(19) United States
(12) Patent Application Publication
(10) Pub. No.: US 2014/0099539 A1
(43) Pub. Date: Apr. 10, 2014

(54) NEGATIVE ELECTRODE FOR LITHIUM-ION SECONDARY BATTERY, MANUFACTURING METHOD THEREOF, AND LITHIUM-ION SECONDARY BATTERY

(71) Applicant: SEMICONDUCTOR ENERGY LABORATORY CO., LTD., Atsugi-shi (JP)

(72) Inventors: Shunpei YAMAZAKI, Tokyo (JP); Teppei OGUNI, Atsugi (JP); Ryota TAJIMA, Isehara (JP)

(73) Assignee: SEMICONDUCTOR ENERGY LABORATORY CO., LTD., Atsugi-shi (JP)

(21) Appl. No.: 14/043,120

(22) Filed: Oct. 1, 2013

(30) Foreign Application Priority Data
Oct. 5, 2012 (JP) 2012-223677

(51) Int. Cl. H01M 4/36; C01B 33/113; H01M 4/04; C01B 33/027

(52) U.S. Cl. CPC H01M 4/366; C01B 33/027; C01B 33/113; H01M 4/0421
USPC 429/211; 429/218.1; 423/349; 423/325; 216/13

(57) ABSTRACT

To provide a lithium-ion secondary battery which has high charge and discharge capacity, is capable of being charged and discharged at high rate and has good cycle characteristics. A negative electrode includes a current collector and a negative electrode active material layer. The current collector includes a plurality of protrusion portions extending in the direction substantially perpendicular to the current collector and a base portion connected to the plurality of protrusion portions. The protrusion portions and the base portion are formed using the same material containing titanium. At least side surfaces of the protrusion portions are covered with the negative electrode active material layer. In the negative electrode active material layer, silicon layers and silicon oxide layers are alternately stacked between a plane where the protrusion portions are in contact with the negative electrode active material layer and a surface of the negative electrode active material layer.

### BACKGROUND OF THE INVENTION

1. Field of the Invention

The present invention relates to a negative electrode for a lithium-ion secondary battery, a manufacturing method of the negative electrode, and a lithium-ion secondary battery.

2. Description of the Related Art

In recent years, with the advance of environmental technology, power generation devices (e.g., solar power generation devices) which pose less burden on the environment than conventional power generation means have been actively developed. Concurrently with the development of power generation technology, development of power storage devices such as lithium-ion secondary batteries, lithium-ion capacitors, and air cells has also been underway.

In particular, with the development of the semiconductor industry, demand for lithium-ion secondary batteries has rapidly grown for electronic devices, for example, portable information terminals such as cell phones, smartphones, and laptop computers, portable music players, and digital cameras; medical equipment; next-generation clean energy vehicles such as hybrid electric vehicles (HEVs), electric vehicles (EVs), and plug-in hybrid electric vehicles (PHEVs); and the like. The lithium-ion secondary batteries are essential as chargeable energy supply sources for today's information society. Especially in the case of applications for electric vehicles or home electrical appliances such as refrigerators, batteries with higher capacity and higher output are desirable.

A negative electrode used in such a lithium-ion secondary battery (a negative electrode for a lithium-ion secondary battery) is manufactured in such a manner that a layer containing an active material (an active material layer) is formed over a surface of a current collector. Graphite (black lead) which is capable of receiving and releasing ions serving as carriers (carrier ions) is a conventional material used as a negative electrode active material. Specifically, a negative electrode has been manufactured in such a manner that graphite as a negative electrode active material, carbon black as a conductive additive, and a resin as a binder are mixed to form slurry, and the slurry is applied over a current collector and dried.

As other negative electrode active materials, silicon and silicon doped with boron or phosphorus can be given. The theoretical capacity of a silicon negative electrode is 4200 mAh/g, which is significantly higher than the theoretical capacity of carbon (black lead) negative electrode of 372 mAh/g. Thus, silicon is an optimal material in terms of increasing the capacity of a power storage device, and lithium-ion secondary batteries formed using silicon as negative electrode active materials have been actively developed today in order to increase the capacity.

However, in the case of a negative electrode formed using silicon as a negative electrode active material, an increase in the number of received carrier ions means an increase in the amount of change in the volume of the active material due to reception and release of carrier ions in charge and discharge cycles, resulting in lower adhesion between a current collector and silicon and deterioration of battery characteristics on charge and discharge. Further, in some cases, a serious problem is caused in that silicon is deformed and broken to be separated or pulverized, so that a function of a battery cannot be maintained.

In Patent Document 1, for example, as a negative electrode active material, a layer formed using microcrystalline or amorphous silicon is formed in a columnar shape or in a powder form over a current collector formed using copper foil or the like with a rough surface, and a layer formed using a carbon material such as graphite which has lower electric conductivity than silicon is provided over the layer formed using silicon. This makes it possible to collect current through the layer formed using a carbon material such as graphite even if the layer formed using silicon is separated; thus, deterioration of battery characteristics can be reduced.

### REFERENCE

[Patent Document 1] Japanese Published Patent Application No. 2001-283834

### SUMMARY OF THE INVENTION

However, in Patent Document 1, when the negative electrode active material layer has either a columnar shape or a powder form and charge and discharge are repeated more than 10 cycles, which is described in the document, expansion and contraction of the volume cannot be avoided as long as carrier ions are received into and released from the negative electrode active material. Thus, deformation and breakage of the negative electrode active material cannot be prevented, and reliability of a battery is difficult to maintain.

Particularly in the case where silicon serving as a negative electrode active material is used in the form of a columnar structure body, the columnar structure body might be separated from a current collector on repeated charge and discharge, and significant reductions in charge and discharge capacity and discharge rate might be caused because of an increase in the number of cycles. This results from the fact that a portion where the current collector is in contact with the columnar structure body is limited to a bottom surface of the columnar structure body as well as expansion and contraction of the entire columnar structure. In Patent Document 1, in view of the above, current is collected in a layer formed using graphite on the assumption that silicon serving as an active material is separated from the current collector. Thus, the structure has a problem in ensuring reliability in terms of cycle characteristics.

In addition, in the case where a layer formed using silicon and provided over a current collector is covered with a layer formed using graphite, the thickness of the layer formed using graphite is large, for example, submicron to micron; thus, the transfer of carrier ions is hindered. Further, since the active material layer contains a large amount of graphite, which has a smaller capacity than silicon, the amount of silicon contained in the active material layer is small. Consequently, the high-rate charge-discharge cycle performance of a lithium-ion secondary battery is degraded and the charge and discharge capacity thereof is reduced.

Further, since only the bottom portion of the columnar structure body of the active material which is described in Patent Document 1 is firmly attached to the rough surface of the current collector, the adhesive strength between the current collector and the active material is extremely low. Thus, the columnar structure body is likely to be separated from the current collector because of expansion and contraction of silicon.

In view of the above, an object of one embodiment of the present invention is to provide a negative electrode for a lithium-ion secondary battery with high charge and discharge capacity.

Another object of one embodiment of the present invention is to provide a negative electrode for a lithium-ion secondary battery capable of being charged and discharged at high rate.

Another object of one embodiment of the present invention is to provide a negative electrode for a highly reliable lithium-ion secondary battery whose battery characteristics are less likely to be degraded on charge and discharge.

Another object of one embodiment of the present invention is to provide a manufacturing method of the negative electrode for the lithium-ion secondary battery.

One embodiment of the present invention is a negative electrode for a lithium-ion secondary battery which includes a current collector and a negative electrode active material layer. The current collector includes a plurality of protrusion portions extending in the direction substantially perpendicular to a surface of the current collector and a base portion connected to the plurality of protrusion portions. The protrusion portions and the base portion are formed using the same material containing titanium. At least side surfaces of the protrusion portions are covered with the negative electrode active material layer. In the negative electrode active material layer, silicon layers and silicon oxide layers are alternately stacked.

Another embodiment of the present invention is a negative electrode for a lithium-ion secondary battery which includes a current collector and a negative electrode active material layer. The current collector includes a plurality of protrusion portions extending in the direction substantially perpendicular to a surface of the current collector and a base portion connected to the plurality of protrusion portions. The protrusion portions and the base portion are formed using the same material containing titanium. At least side surfaces of the protrusion portions are covered with the negative electrode active material layer. The negative electrode active material layer is formed of a mixture of silicon and an elastic resin material.

In the negative electrode current collector, the base portion is much thicker than the protrusion portions and functions as an electrode terminal. Meanwhile, the plurality of protrusion portions are formed on a surface of the base portion, have a function of increasing the surface area of the negative electrode current collector, and also function as cores of the negative electrode active material layer. The plurality of protrusion portions extend in the direction substantially perpendicular to the surface of the base portion. In this specification, the term “substantially” is used to mean a slight deviation from the direction perpendicular to the current collector due to an error in leveling in a manufacturing process of the negative electrode current collector, step variation in a manufacturing process of the protrusion portions, deformation on repeated charge and discharge, and the like is acceptable although the angle between the surface of the base portion and a center axis of the protrusion portion in the longitudinal direction is preferably 90°. Specifically, the angle between the surface of the base portion and the center axis of the protrusion portion in the longitudinal direction is 90° with a margin of error of plus or minus 10°, preferably 90° with a margin of error of plus or minus 5°. Note that the direction in which the plurality of protrusion portions extend from the base portion is referred to as the longitudinal direction.

Titanium is particularly preferable as a material for the negative electrode current collector. Titanium has higher strength than steel, and has a mass less than or equal to half of that of steel and thus is very light. Further, titanium has strength about twice as high as that of aluminum and is less likely to have metal fatigue than other metals. Thus, titanium allows a light battery to be obtained and can function as a core of a negative electrode active material layer which has resistance to repeated stress; thus, deterioration or breakage due to expansion and contraction of silicon can be suppressed. Moreover, titanium is very suitable to be processed by dry etching and enables a protrusion portion with a high aspect ratio to be formed on a surface of a current collector.

Silicon is used for the negative electrode active material. As the silicon, amorphous silicon, microcrystalline silicon, polycrystalline silicon, or a combination thereof can be used. An impurity imparting conductivity, such as phosphorus or boron, may be added to such silicon.

One embodiment of the present invention is a manufacturing method of a negative electrode for a lithium-ion secondary battery. The manufacturing method includes a first step of forming a photoresist pattern over a current collector material containing titanium; a second step of etching the current collector material with the use of the photoresist pattern as a mask to form a current collector including a plurality of protrusion portions and a base portion connected to the plurality of protrusion portions; a third step of forming a silicon layer so that the silicon layer covers the top surfaces and side surfaces of the protrusion portions and the top surface of the base portion with the use of a deposition gas containing silicon; and a fourth step of partly removing the silicon layer by anisotropic etching so that the base portion is exposed. In the third step, momentary introduction of an oxidizing gas is performed a plurality of times.

The negative electrode current collector includes the base portion and the plurality of protrusion portions protruding from the base portion. The plurality of protrusion portions extend in the substantially direction perpendicular to the current collector; thus, the density of protrusion portions in the negative electrode can be increased and the surface area can be increased. Therefore, a lithium-ion secondary battery with high charge and discharge capacity can be manufactured.

Further, a space is provided between adjacent protrusion portions of the plurality of protrusion portions. Thus, even when an active material expands by charging, contact between the protrusion portions (protrusion portions whose side surfaces are provided with active material layers) can be avoided, and even when the active material is partly separated from the base, the entire separation of the active material can be prevented. In particular, when the protrusion portions are formed using titanium, the protrusion portions function as cores of the negative electrode active material layer which have high mechanical strength; thus, cyclic degradation of silicon due to expansion and contraction can be controlled.

The negative electrode of one embodiment of the present invention can suppress expansion and contraction of silicon serving as the negative electrode active material in the negative electrode active material layer due to insertion and extraction of carrier ions. Thus, cracking and separation of the negative electrode active material on repeated charge and discharge can be inhibited, which greatly helps reduce cyclic degradation of the negative electrode active material layer.

The plurality of protrusion portions have translation symmetry and are formed with high uniformity in the negative electrode, so that local reaction can be reduced in each of a positive electrode and the negative electrode, and carrier ions and the active material react with each other uniformly between the positive electrode and the negative electrode.

Thus, in the case where the negative electrode is used for a lithium-ion secondary battery, high-rate charge and discharge are possible, and breakdown and separation of the active material on charge and discharge can be suppressed. In other words, a lithium-ion secondary battery with further improved charge and discharge cycle characteristics and high reliability can be manufactured.

According to one embodiment of the present invention, a negative electrode for a lithium-ion secondary battery with high charge and discharge capacity can be provided.

According to one embodiment of the present invention, a negative electrode for a lithium-ion secondary battery capable of being charged and discharged at high rate can be provided.

According to one embodiment of the present invention, a negative electrode for a highly reliable lithium-ion secondary battery whose battery characteristics are less likely to be degraded on charge and discharge can be provided.

According to one embodiment of the present invention, a manufacturing method of the negative electrode for the lithium-ion secondary battery can be provided.

### BRIEF DESCRIPTION OF THE DRAWINGS

In the accompanying drawings:

FIGS. 1A and 1B illustrate a negative electrode;

FIGS. 2A to 2C each illustrate a negative electrode;

FIGS. 3A and 3B illustrate a negative electrode;

FIGS. 4A to 4I each illustrate the shape of a protrusion portion of a negative electrode current collector;

FIGS. 5A to 5D each illustrate a negative electrode current collector;

FIGS. 6A to 6C illustrate a manufacturing method of a negative electrode;

FIGS. 7A and 7B illustrate a manufacturing method of a negative electrode;

FIGS. 8A and 8B illustrate a manufacturing method of a negative electrode;

FIGS. 9A and 9B illustrate a manufacturing method of a negative electrode;

FIGS. 10A and 10B illustrate the manufacturing method of a negative electrode;

FIGS. 11A to 11D illustrate a manufacturing method of a negative electrode;

FIGS. 12A to 12D illustrate a manufacturing method of a negative electrode;

FIGS. 13A to 13C illustrate a manufacturing method of a negative electrode;

FIGS. 14A to 14C each illustrate a negative electrode;

FIGS. 15A and 15B illustrate an electrophoresis method and an electrochemical reduction method, respectively;

FIGS. 16A to 16C illustrate a positive electrode;

FIGS. 17A and 17B illustrate a positive electrode;

FIGS. 18A and 18B each illustrate a separator-less lithium-ion secondary battery;

FIGS. 19A and 19B illustrate a coin-type lithium-ion secondary battery;

FIGS. 20A and 20B illustrate a cylindrical lithium-ion secondary battery;

FIG. 21 illustrates electronic devices;

FIGS. 22A to 22C illustrate an electronic device; and

FIGS. 23A and 23B illustrate an electronic device.

### DETAILED DESCRIPTION OF THE INVENTION

Hereinafter, embodiments of the present invention will be described in detail with reference to the accompanying drawings. However, the present invention is not limited to the descriptions of the embodiments, and it is easily understood by those skilled in the art that the modes can be modified in various ways. Therefore, the present invention should not be construed as being limited to the descriptions in the following embodiments.

Note that in drawings used in this specification, the thicknesses of films, layers, and substrates and the sizes of components (e.g., the sizes of regions) are exaggerated for simplicity in some cases. Therefore, the sizes of the components are not limited to the sizes in the drawings and relative sizes between the components.

Note that the ordinal numbers such as “first” and “second” in this specification and the like are used for convenience and do not denote the order of steps, the stacking order of layers, or the like. In addition, the ordinal numbers in this specification and the like do not denote particular names which specify the present invention.

Note that in structures of the present invention described in this specification and the like, the same portions or portions having similar functions are denoted by common reference numerals in different drawings, and descriptions thereof are not repeated. Further, the same hatching pattern is applied to portions having similar functions, and the portions are not especially denoted by reference numerals in some cases.

Note that in this specification and the like, a positive electrode and a negative electrode for a power storage device may be collectively referred to as an electrode; in this case, the electrode in this case refers to at least one of the positive electrode and the negative electrode.

### Embodiment 1

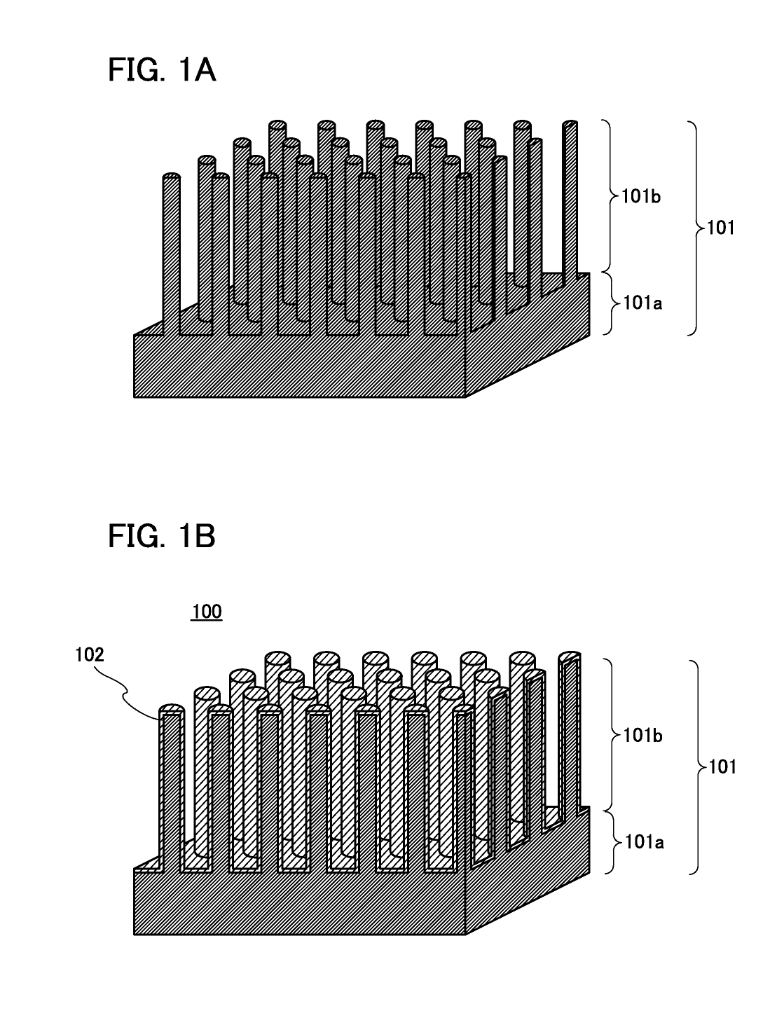

In this embodiment, the structure of a negative electrode for a lithium-ion secondary battery which is less likely to deteriorate on charge and discharge and has excellent charge-discharge cycle performance and a manufacturing method of the negative electrode will be described with reference to FIGS. 1A to 14C.

Here, a secondary battery in which lithium ions are used as carrier ions is referred to as a lithium-ion secondary battery. Examples of carrier ions which can be used instead of lithium ions are alkali-metal ions such as sodium ions and potassium ions; alkaline-earth metal ions such as calcium ions, strontium ions, barium ions, beryllium ions, and magnesium ions.

### (Structure of Negative Electrode)

FIG. 1A is a schematic cross-sectional view of an enlarged surface portion of a negative electrode current collector. A negative electrode current collector 101 includes a plurality of protrusion portions 101b and a base portion 101a to which each of the plurality of protrusion portions is connected. Thus, the negative electrode current collector 101 has a structure like that of a spiky frog (kenzan) used in the Japanese art of flower arrangement. Although the base portion 101a which is thin is illustrated in the drawing, the base portion 101a is generally much thicker than the protrusion portions 101b.

The plurality of protrusion portions 101b extend in the direction substantially perpendicular to a surface of the base portion 101a. Here, “the direction substantially perpendicular to” means that a slight deviation from the direction perpendicular to the current collector due to an error in leveling in a manufacturing process of the negative electrode current collector 101, step variation in a manufacturing process of the protrusion portions 101b, deformation on repeated charge and discharge, and the like is acceptable although the angle between the surface of the base portion 101a and a center axis of the protrusion portion 101b in the longitudinal direction is preferably 90°. Specifically, the angle between the surface of the base portion 101a and the center axis of the protrusion portion 101b in the longitudinal direction is less than or equal to 90°±10°, preferably less than or equal to 90°±5°. Note that the direction in which the plurality of protrusion portions 101b extend from the base portion 101a is referred to as the longitudinal direction.

The current collector 101 is generally formed to a thickness of 3 μm to 100 μm. There is no particular limitation on the current collector 101 as long as it exhibits high conductivity without causing chemical changes in a battery. Examples of the current collector material are metals such as stainless steel, gold, platinum, copper, iron, or titanium, an alloy thereof, sintered carbon, copper or stainless steel whose surface is treated with carbon, nickel, titanium, or the like, and a metal element that forms silicide. Examples of the metal element which reacts with silicon to form a silicide are zirconium, titanium, hafnium, vanadium, niobium, tantalum, chromium, molybdenum, tungsten, cobalt, and nickel.

Titanium is particularly preferable as a material for the negative electrode current collector 101. Titanium has mass which is less than or equal to half of that of steel and thus is very light while having higher strength than steel. Moreover, titanium has strength about twice as high as that of aluminum and is less likely to have metal fatigue than any other metals. Thus, the use of titanium enables fabrication of a light battery and titanium can function as a core of a negative electrode active material layer 102 which has resistance to repeated stress, so that deterioration or breakage due to expansion and contraction of silicon can be controlled. Moreover, titanium is very suitable to be processed by dry etching and allows the protrusion portion 101b having a high aspect ratio to be formed on a surface of the current collector.

The current collector can be made in any of various forms including films, sheets, foils, nets, porous structures, and non-woven fabrics. In addition, the negative electrode current collector 101 can have a foil shape, a plate shape (sheet shape), a net shape, a punching-metal shape, an expanded-metal shape, or the like as appropriate. In the case where a current collector material having a shape with an opening, such as a net shape, the protrusion portion 101b is formed on a surface of the current collector material other than the opening in a subsequent step. The current collector may be formed to have micro irregularities on the surface thereof in order to enhance adhesion to the active material layer, for example.

FIG. 1B is a cross-sectional view of a negative electrode 100 in which the negative electrode current collector 101 is provided with the negative electrode active material layer 102. The negative electrode active material layer 102 is provided so as to cover a top surface of the base portion 101a on which the protrusion portion 101b is not provided and side surfaces and top surfaces of the protrusion portions 101b, that is, an exposed surface of the negative electrode current collector 101.

Note that “active material” refers to a material that relates to reception and release of carrier ions. An active material layer may include, in addition to an active material, one or more of a conductive additive, a binder, a graphene, and the like. Thus, the active material and the active material layer are distinguished.

The negative electrode active material layer 102 is formed using any one or more of silicon, germanium, tin, aluminum, and the like, which are capable of receiving and releasing ions serving as carriers. Note that silicon is preferably used for the negative electrode active material layer 102 because of its high theoretical charge and discharge capacity. In the case where silicon is used as a negative electrode active material, silicon has higher theoretical carrier ion reception capacity than graphite currently used; thus, an increase in capacity of a lithium-ion secondary battery or a reduction in size of a lithium-ion secondary battery can be achieved.

In the case where silicon is used for the negative electrode active material layer 102, amorphous silicon, microcrystalline silicon, polycrystalline silicon, or a combination thereof can be used.

As an example in which plural kinds of crystalline silicon are combined, a polycrystalline silicon film is formed over the protrusion portions 101b and an amorphous silicon film is formed over the polycrystalline silicon film, whereby the negative electrode active material layer 102 can have a two-layer structure of the polycrystalline silicon film and the amorphous silicon film. In this case, higher conductivity can be secured by the polycrystalline silicon film on the inner side and the amorphous silicon film around the polycrystalline silicon film can receive carrier ions. Alternatively, instead of the two-layer structure, the negative electrode active material layer 102 can have a structure in which a silicon film is formed to have a polycrystalline silicon portion on the inner side in contact with the current collector (the protrusion portion 101b) and an amorphous silicon portion toward the outer side of the current collector (the protrusion portion 101b) so that the crystallinity continuously varies. Also in this case, an effect similar to that of the two-layer structure can be obtained.

Further, silicon used for the negative electrode active material layer 102 preferably contains a resin material having elasticity in order to decrease the elastic modulus of the negative electrode active material layer 102. The decrease in the elastic modulus of the negative electrode active material layer 102 leads to suppression of deterioration or breakage due to expansion and contraction of the negative electrode active material layer 102.

As the resin material having elasticity, synthetic rubber can be used, for example.

Alternatively, as the resin material having elasticity, a known binder may be used.

In the case of using a known binder, the negative electrode active material layer 102 can be formed using, for example, slurry containing silicon particles and poly(vinylidene fluoride) (PVDF) as a binder. The slurry is applied to the negative electrode current collector 101 obtained by combining the base portion 101a and the protrusion portions 101b and is dried, whereby the negative electrode active material layer 102 can be formed.

Specifically, liquid cyclopentasilane and PVDF as a known binder are used to form slurry. As for the composition ratio of cyclopentasilane and PVDF, it is preferable that the slurry contain PVDF at less than 50 wt %. Then, the slurry is applied to the negative electrode current collector 101 including the base portion 101a and the protrusion portions 101b. After that, ultraviolet irradiation is performed to make hydrogen released from cyclopentasilane, so that the negative electrode active material layer 102 including silicon and a resin material having elasticity can be formed.

In another example in which plural kinds of crystalline silicon are combined, amorphous silicon can be used for the negative electrode active material layer 102 which covers the protrusion portions 101b and polycrystalline silicon can be used for the negative electrode active material layer 102 which covers the base portion 101a.

Alternatively, silicon to which an impurity element imparting one conductivity type, such as phosphorus or boron, is added may be used for the negative electrode active material layer 102. The silicon to which the impurity element imparting one conductivity type, such as phosphorus or boron, is added has higher conductivity; therefore, the conductivity of the negative electrode 100 can be increased.

The base portion 101a functions as a terminal of a lithium-ion secondary battery and also as a base of the plurality of protrusion portions 101b. The base portion 101a and the plurality of protrusion portions 101b are formed using the same material and are physically continuous. Therefore, the protrusion portion 101b and the base portion 101a are combined to be strongly bonded to each other in a connection portion therebetween, so that the connection portion has strength high enough to withstand the stress particularly concentrated because of expansion and contraction of the negative electrode active material layer 102 provided so as to cover the base portion 101a and the protrusion portion 101b. Thus, the protrusion portion 101b can function as a core of the negative electrode active material layer 102.

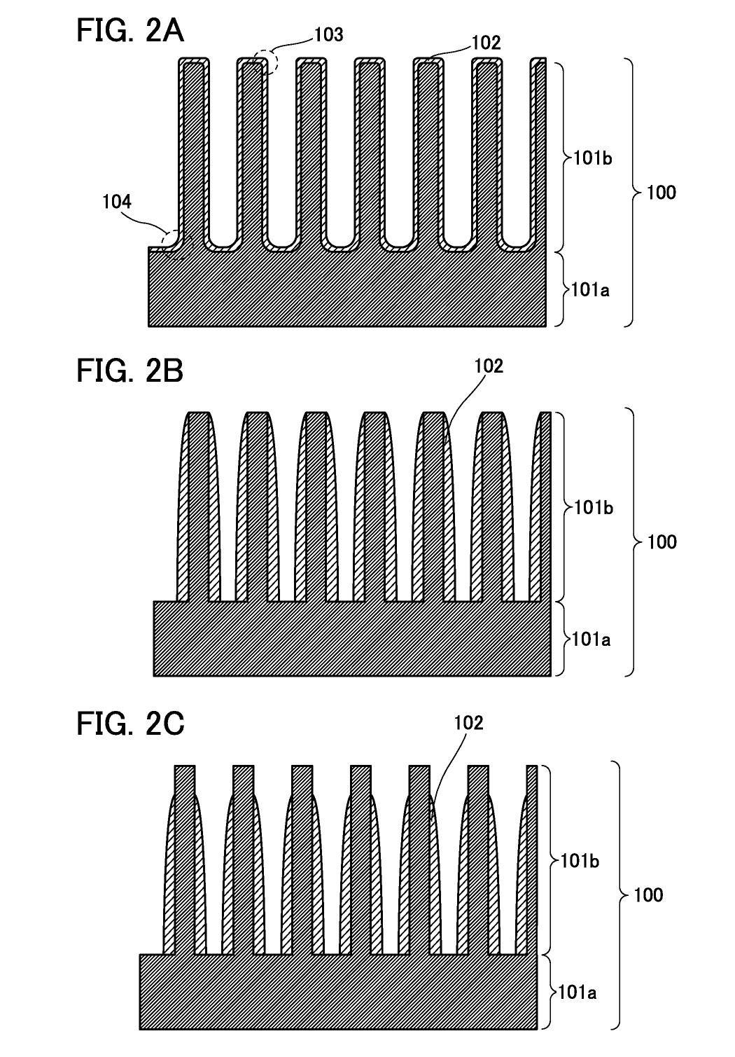

As illustrated in FIG. 2A, it is particularly preferable that the protrusion portion 101b be curved inward in the vicinity (portion 104) of the connection portion with the base portion 101a. Specifically, a basal portion of the protrusion portion 101b is curved so that a surface of the base portion 101a and a side surface of the protrusion portion 101b form a smooth curved surface without a corner, whereby stress is prevented from being concentrated on one point, and the protrusion portion 101b can have a strong structure.

Further, as illustrated in FIG. 2A, a boundary portion 103 between the side surface and the top surface of the protrusion portion 101b is curved, whereby stress concentration on an edge portion can be reduced and mechanical strength against pressure applied from above the negative electrode 100 can be obtained.

The plurality of protrusion portions 101b protrude from the base portion 101a in the negative electrode current collector 101; thus, the surface area of the negative electrode active material layer 102 which covers the current collector is larger than that in the case of using a plate-like current collector. Further, the plurality of protrusion portions 101b extend in the same direction and the protrusion portions protrude in the direction perpendicular to the base portion 101a, so that the density of the protrusion portions 101b in the negative electrode 100 can be increased, leading to an increase in surface area.

Further, spaces are provided between the plurality of protrusion portions 101b, whereby contact between active materials covering the protrusion portions 101b can be reduced even when the active materials are expanded by insertion of lithium ions.

In this embodiment, the plurality of protrusion portions 101b have translation symmetry and are formed with high uniformity in the negative electrode 100, so that local reaction can be reduced in each of the positive electrode and the negative electrode, and carrier ions and the active material react with each other uniformly between the positive electrode and the negative electrode. Thus, in the case where the negative electrode 100 is used to fabricate a lithium-ion secondary battery, fast charge and discharge become possible and breakdown and separation of the active material on charge and discharge can be suppressed; accordingly, the lithium-ion secondary battery can have improved cycle performance.

Furthermore, the shapes of the protrusion portions 101b can be substantially the same, so that local charge and discharge can be reduced and the weight of the active material can be controlled. In addition, when the heights of the protrusion portions 101b are substantially the same, load can be prevented from being applied locally in a manufacturing process of a battery, which results in an increase in the yield. Accordingly, specifications of the battery can be well controlled.

Note that as illustrated in FIGS. 2B and 2C, a structure may be employed in which the side surfaces of the protrusion portions 101b are provided with the negative electrode active material layers 102, the top surfaces of the protrusion portions 101b are not provided with the negative electrode active material layers 102, and the top surface of the base portion 101a is partly exposed. Alternatively, although not illustrated, a structure may be employed in which the negative electrode active material layer 102 is formed on only the side surfaces and top surfaces of the protrusion portions 101b. Although, in these cases, there is a disadvantage of a reduction in discharge capacity due to a reduction in the surface area of the negative electrode active material layer 102, expansion of the negative electrode active material with which the side surfaces of the protrusion portions 101b is provided is not suppressed at basal portions of the protrusion portions 101b; thus, generation of cracks or deformation and breakage can be reduced. Accordingly, the reliability of a lithium-ion secondary battery can be improved. Further, in the case where the top surfaces of the protrusion portions 101b are exposed, flatness of the top surfaces of the protrusion portions 101b, which might be lost when the top surfaces of the protrusion portions 101b are covered with the negative electrode active material layer 102, can be maintained.

In the case where the negative electrode active material layers 102 are provided on only the side surfaces of the protrusion portions 101b, the negative electrode active material layers 102 can be provided on the entire side surfaces of the protrusion portions 101b as illustrated in FIG. 2B, or parts of the side surfaces of the protrusion portions 101b can be exposed as illustrated in FIG. 2C. In the former case, the surface area of the negative electrode active material layer 102 is larger than that in the latter case; thus, the discharge capacity in the former case is higher than that in the latter case. In the latter case, for example, upper parts of the side surfaces of the protrusion portions 101b are exposed so that spaces which allow upward expansion of the negative electrode active material layer 102 at the time of reception of carrier ions can be provided.

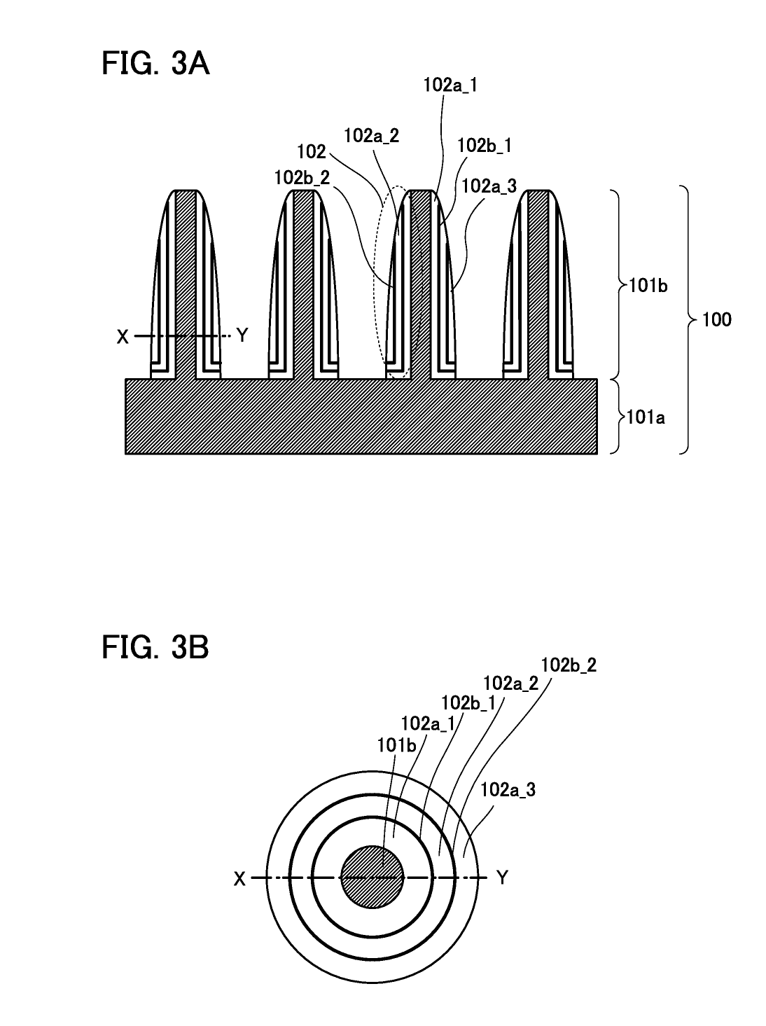

Alternatively, the negative electrode active material layer 102 may have a structure where plural kinds of layers are stacked by turns between a plane where the protrusion portions 101b are in contact with the negative electrode active material layer 102 and a surface of the negative electrode active material layer 102. An example of the above structure will be described with reference to FIGS. 3A and 3B.

FIG. 3A is a cross-sectional view of the negative electrode 100 in which the negative electrode current collector 101 is provided with the negative electrode active material layers 102. FIG. 3B is a cross-sectional view along X-Y in FIG. 3A.

In the negative electrode 100 illustrated in FIGS. 3A and 3B, the side surfaces of the protrusion portions 101b are provided with the negative electrode active material layers 102, the top surfaces of the protrusion portions 101b are not provided with the negative electrode active material layers 102, and the top surface of the base portion 101a is partly exposed, as in FIG. 2B. Although a smaller number of protrusion portions 101b are illustrated for convenience in FIGS. 3A and 3B, the number of the protrusion portions 101b is not limited to that in FIGS. 3A and 3B and may be, for example, larger than or equal to the number of the protrusion portions 101b of the negative electrode 100 in FIG. 2B.

Further, in the negative electrode 100 illustrated in FIGS. 3A and 3B, a plurality of silicon layers 102a and a plurality of silicon oxide layers 102b are alternately stacked between the surface of the negative electrode active material layer 102 and the plane where the protrusion portions 101b in the negative electrode current collector 101 are in contact with the negative electrode active material layer 102. FIGS. 3A and 3B illustrate an example where a silicon layer 102a_1, a silicon oxide layer 102b_1, a silicon layer 102a_2, a silicon oxide layer 102b_2, and a silicon layer 102a3 are stacked in this order.

The silicon layers 102a (the silicon layers 102a_1 to 102a_3 in FIGS. 3A and 3B) function as the negative electrode active material layer 102 illustrated in FIG. 2A. Note that a layer formed using any other material may be used as long as it has the same function as the silicon layer 102a.

The silicon oxide layers 102b are layers into/from which carrier ions can be inserted/extracted. The silicon oxide layers 102b (the silicon oxide layers 102b_1 and 102b_2 in FIGS. 3A and 3B) are less likely to expand and contract because of carrier ions than the silicon layers 102a. The silicon oxide layers 102b have a function of suppressing expansion and contraction of the silicon layers 102a due to insertion and extraction of carrier ions.

The silicon oxide layer 102b is preferably thinner than the silicon layer 102a. When the silicon oxide layer 102b is formed as thin as possible, an influence on insertion and extraction of carrier ions can be reduced. Note that a layer formed using any other material may be used as long as it has the same function as the silicon oxide layer 102b.

In the structure illustrated in FIGS. 3A and 3B, the silicon oxide layers 102b can suppress expansion and contraction of silicon serving as a negative electrode active material due to insertion and extraction of carrier ions.

Note that there is no particular limitation on the number of the silicon oxide layers 102b to be stacked and the number of the silicon layers 102a to be stacked. For example, an increase in the number of the layers can enhance the effect of suppressing expansion and contraction of the negative electrode active material layer 102 due to insertion and extraction of carrier ions. The total number of the silicon oxide layers 102b and the silicon layers 102a is preferably greater than or equal to 10, more preferably greater than or equal to 100.

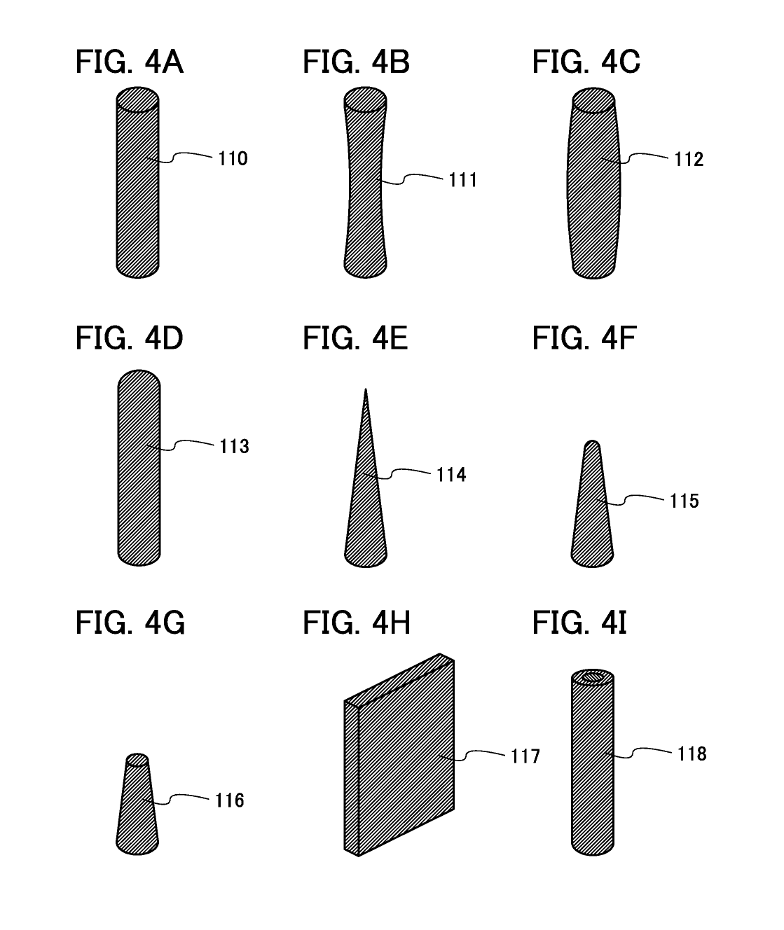

Next, shapes of the protrusion portion 101b in this embodiment will be described with reference to FIGS. 4A to 41. A columnar protrusion 110 illustrated in FIG. 4A can be used as the protrusion portion 101b. Since the shape of a cross section which is parallel to the base portion 101a is circular in the columnar protrusion 110, stress is applied isotropically from all directions; thus, a uniform negative electrode can be obtained. FIGS. 4B and 4C similarly illustrate columnar protrusions: a protrusion 111 whose side surface is depressed inward and a protrusion 112 whose side surface expands outward. These shapes are more capable of controlling stress applied to the protrusions than the simple columnar protrusion illustrated in FIG. 4A; therefore, when any of the shapes is employed, the mechanical strength can be increased by an appropriate structure design. A protrusion 113 illustrated in FIG. 4D has a structure different from that of the column (the protrusion 110) illustrated in FIG. 4A in that the top surface of the protrusion is curved. In the protrusion 113, stress applied to an edge portion of the top surface can be reduced more than in the columnar protrusion 110 illustrated in FIG. 4A, and coverage with a negative electrode active material layer formed covering the protrusion 113 can be improved more than in the columnar protrusion 110 illustrated in FIG. 4A. FIG. 4E illustrates a conical protrusion 114. FIG. 4F illustrates a conical protrusion 115 which has a rounded top. FIG. 4G illustrates a conical protrusion 116 with a flat end. As in the protrusions 114, 115, and 116, the conical shape particularly enables an increase in the connection area with a base portion of a negative electrode current collector, leading to an increase in resistance to stress. FIG. 41-1 illustrates a plate-like protrusion 117. FIG. 41 illustrates a pipe-like protrusion 118. When the protrusion 101b has the shape of the pipe-like protrusion with a cavity inside, a negative electrode active material can be provided also in the cavity, so that the discharge capacity of the negative electrode 100 can be increased.

In the case where any of the shapes of the above protrusions 110 to 118 is employed for the protrusion portion 101b, the protrusion portion 101b is preferably curved inward in the vicinity (portion 104) of the connection portion with the base portion 101a as illustrated in FIG. 2A. A basal portion of the protrusion portion 101b is curved so that a surface of the base portion 101a and a side surface of the protrusion portion 101b form a smooth curved surface without a corner, whereby stress is prevented from being concentrated on one point, and the protrusion portion 101b can have a strong structure.

The above shapes of the protrusion portion 101b are only examples and the shape of the protrusion portion 101b described in this embodiment is not limited to those of the protrusions 110 to 118. The protrusion portion 101b may have a combination of any of these shapes or a modified form of any of these shapes. Alternatively, a plurality of shapes of the protrusions may be selected from those of the protrusions 110 to 118 for the plurality of protrusion portions 101b.

In particular, the protrusions 110, 111, 112, 116, 117, and 118 each have a flat surface at the end and thus can support a spacer described later with the flat surface in the case where the spacer is provided over the protrusions; for this reason, the above protrusions are suitable for a separator-less structure. Note that in FIG. 1A, the shape of the columnar protrusion 110 is used for the protrusion portion 101b.

In the protrusion with a flat end, the shape of the flat surface is not limited to circular shapes as in the protrusions 110, 111, 112, and 116, a rectangular shape as in the protrusion 117, and a toroidal shape as in the protrusion 118, and may be any shape by which a flat surface can be formed, e.g., an elliptical shape or a polygonal shape.

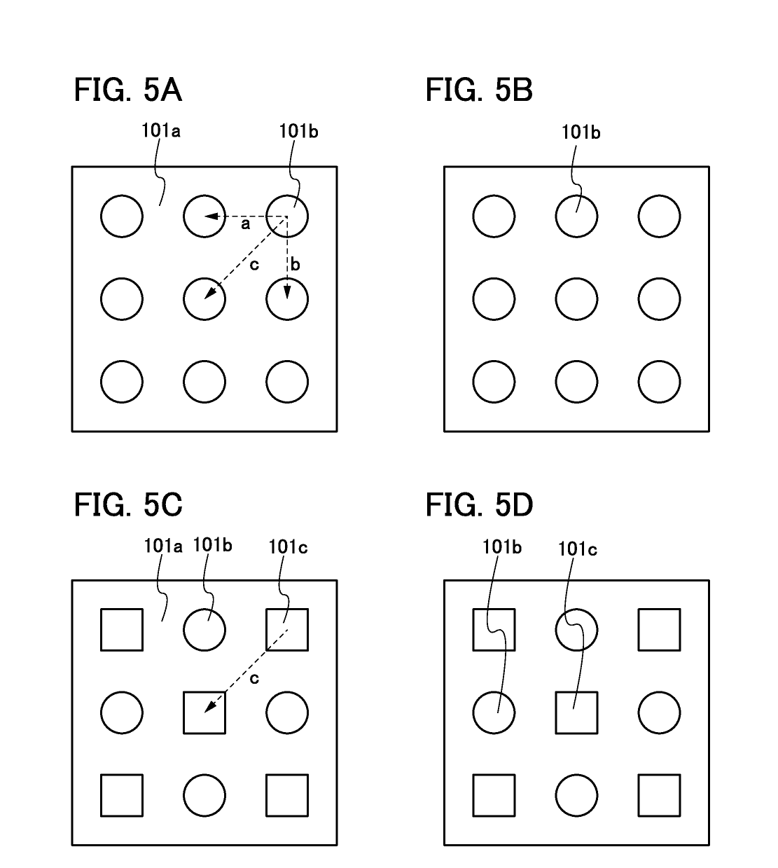

Shapes of the top surface of the negative electrode current collector in this embodiment will be described with reference to FIGS. 5A to 5D.

FIG. 5A is a top view illustrating the base portion 101a and the plurality of protrusion portions 101b protruding from the base portion 101a. Here, the plurality of protrusion portions 101b with circular top surfaces are arranged. FIG. 5B is a top view after movement of the plurality of protrusion portions 101b in FIG. 5A in the direction a. In FIGS. 5A and 5B, the plurality of protrusion portions 101b are located at the same positions. Here, the plurality of protrusion portions 101b in FIG. 5A move in the direction a; however, the same result as that in FIG. 5B can be obtained after movement in the direction b or c. In other words, in plane coordinates where the cross sections of the plurality of protrusion portions 101b illustrated in FIG. 5A are arranged, the plurality of protrusion portions 101b have translation symmetry in which the positions of the protrusion portions are symmetric in translational operation.

FIG. 5C is a top view illustrating the base portion 101a and the plurality of protrusion portions 101b and a plurality of protrusion portions 101c protruding from the base portion 101a. Here, the protrusion portions 101b with circular top surfaces and the protrusion portions 101c with square top surfaces are alternately arranged. FIG. 5D is a top view after movement of the protrusion portions 101b and 101c in the direction c. In the top views of FIGS. 5C and 5D, the protrusion portions 101b and 101c are located at the same positions. In other words, the plurality of protrusion portions 101b and 101c illustrated in FIG. 5C have translation symmetry.

By thus providing the plurality of protrusion portions such that they have translation symmetry, variation in electron conductivity among the plurality of protrusion portions can be reduced. Accordingly, local reaction in the positive electrode and the negative electrode can be reduced, reaction of carrier ions and the active material can occur uniformly, and diffusion overvoltage (concentration overvoltage) can be prevented, so that the reliability of battery characteristics can be increased.

The width (diameter) of each of the plurality of protrusion portions 101b in the cross section is greater than or equal to 50 nm and less than or equal to 5 μm. The height of each of the plurality of protrusion portions 101b is greater than or equal to 1 μm and less than or equal to 100 μm. Thus, the aspect ratio of each of the plurality of protrusion portions 101b is greater than or equal to 0.2 and less than or equal to 2000.

The “height” of the protrusion portion 101b here means the length of a perpendicular line drawn from the top (or the top surface) of the protrusion portion 101b to the surface of the base portion 101a in the cross-sectional shape in the longitudinal direction of the protrusion portion 101b. Note that the boundary between the base portion 101a and the protrusion portion 101b is not always clear because the base portion 101a and the protrusion portion 101b are formed using the same current collector material as will be described later. For this reason, a plane in the current collector (the protrusion portion 101b), which is level with the top surface of the base portion 101a in a contact portion between the base portion 101a and the protrusion portion 101b of the current collector is defined as the boundary between the base portion 101a and the protrusion portion 101b. Here, the boundary between the base portion 101a and the protrusion portion 101b is not included in the top surface of the base portion 101a. In the case where the top surface of the base portion 101a is rough, the top surface of the base portion 101a is defined by the position obtained by average surface roughness.

The distance between the adjacent protrusion portions 101b is preferably 3 times or more and less than 5 times the thickness of the negative electrode active material layer 102 with which the protrusion portion 101b is provided. When the distance between the adjacent protrusion portions 101b is twice the thickness of the negative electrode active material layer 102, there is no space between the adjacent protrusion portions 101b after the formation of the negative electrode active material layer 102; on the other hand, when the distance is five times or more the thickness of the negative electrode active material layer 102, the area of the exposed base portion 101a is increased, which has a smaller effect of increasing the surface area of the negative electrode 100 by the formation of the protrusion portions 101b.

The thickness of the negative electrode active material layer 102 is preferably greater than or equal to 50 nm and less than or equal to 5 μm. This thickness range is substantially the same as the design margin of the diameter of the protrusion portion 101b. In the case where the thickness of the negative electrode active material layer 102 is greater than or equal to 50 nm, charge and discharge capacity can be high. In the case where the thickness of the negative electrode active material layer 102 is less than or equal to 5 μm, breakage can be prevented even when the negative electrode active material layer 102 expands and contracts on charge and discharge.

Consequently, even when the volume of the protrusion portions 101b increases on charge of a lithium-ion secondary battery including the negative electrode 100, the protrusion portions 101b do not come into contact with each other and thus can be prevented from being broken, and a reduction in the charge and discharge capacity of the lithium-ion secondary battery can be prevented.

### (Manufacturing Method 1 of Negative Electrode)

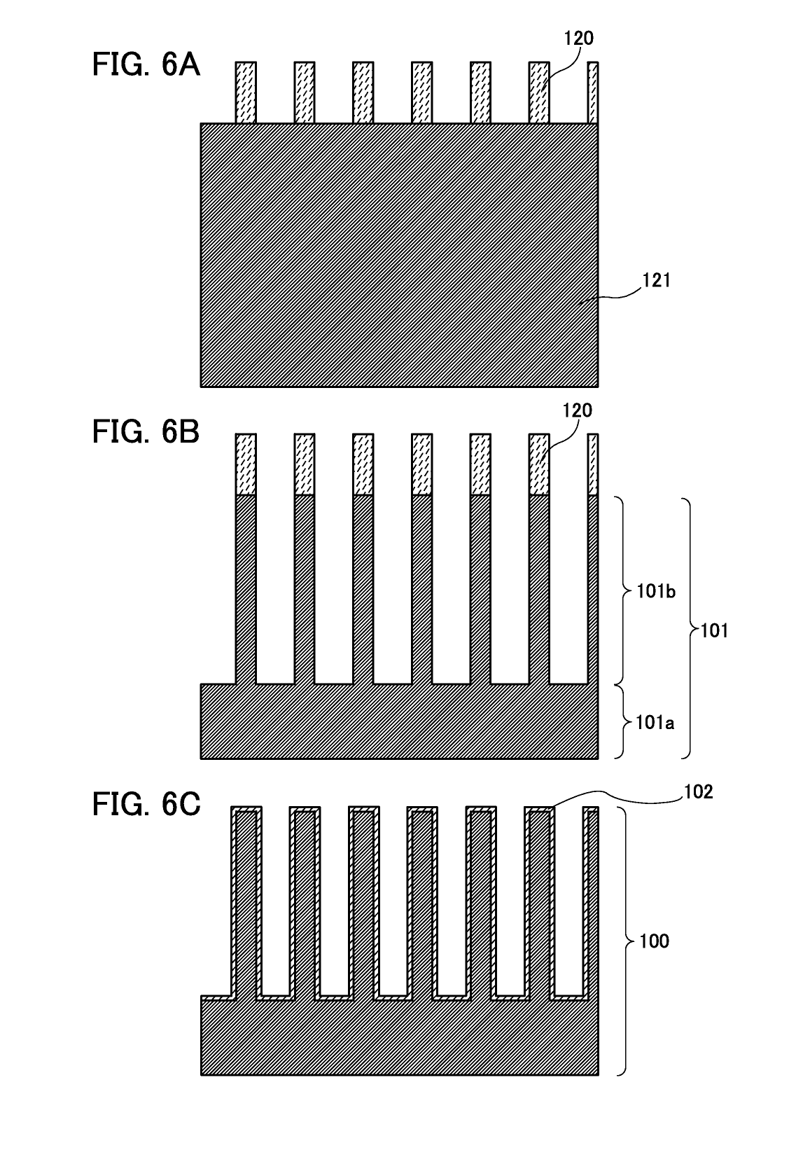

Next, a manufacturing method of the negative electrode 100 illustrated in FIG. 1B will be described with reference to FIGS. 6A to 6C.

As illustrated in FIG. 6A, a photoresist pattern 120 which serves as a mask in an etching step is formed over a current collector material 121.

The current collector material 121 is formed to a thickness of 3 μm to 100 μm. There is no particular limitation on the current collector as long as it exhibits high conductivity without causing chemical changes in a battery. Examples of the current collector material are metals such as stainless steel, gold, platinum, copper, iron, or titanium, an alloy thereof, sintered carbon, copper or stainless steel whose surface is treated with carbon, nickel, titanium, or the like, and a metal element that forms silicide. Examples of the metal element which reacts with silicon to form a silicide are zirconium, titanium, hafnium, vanadium, niobium, tantalum, chromium, molybdenum, tungsten, cobalt, and nickel. Note that the current collector material 121 is preferably formed using an alloy to which an element which improves heat resistance, such as silicon, titanium, neodymium, scandium, or molybdenum, is added.

Titanium is particularly preferable as the current collector material 121. Titanium has higher strength than steel, has mass which is less than or equal to half of that of steel, and is very light. Moreover, titanium has strength about twice as high as that of aluminum and is less likely to have metal fatigue than any other metals. Thus, the use of titanium enables fabrication of a light battery and titanium functions as a core of a negative electrode active material layer 102, so that deterioration or breakage due to expansion and contraction of silicon can be suppressed. Moreover, titanium is very suitable to be processed by dry etching and allows the protrusion portion 101b having a high aspect ratio to be formed on a surface of the current collector.

The current collector material 121 can be made in any of various forms including films, sheets, foils, nets, porous structures, and non-woven fabrics. In addition, the current collector material 121 can have a foil shape, a plate shape (sheet shape), a net shape, a punching-metal shape, an expanded-metal shape, or the like as appropriate. In the case of using the current collector material 121 which has a shape with an opening, such as a net shape, the protrusion portion 101b is formed on a surface of the current collector material 121 other than the opening in a subsequent step. The current collector may be formed to have micro irregularities on the surface thereof in order to enhance adhesion to the active material layer, for example.

The photoresist pattern 120 is exposed to light and developed in a photolithography process to be formed into a desired shape. Alternatively, the photoresist pattern 120 can be formed by an inkjet method, a printing method, or the like, instead of photolithography.

Next, the current collector material 121 is selectively etched using the photoresist pattern 120, whereby the negative electrode current collector 101 including the base portion 101a and the plurality of protrusion portions 101b is formed as illustrated in FIG. 6B. As a method for etching the current collector material 121, a dry etching method or a wet etching method can be employed as appropriate. Particularly in the case where the protrusion portion 101b which has a high aspect ratio is formed, a dry etching method is preferably employed.

For example, the current collector material 121 is etched using a mixed etching gas of BCl₃ and Cl₂ with an inductively coupled plasma (ICP) apparatus, whereby the negative electrode current collector 101 including the base portion 101a and the plurality of protrusion portions 101b can be formed. The flow ratio of the etching gas may be adjusted as appropriate. For example, the flow ratio of BCl₃ to Cl₂ can be set to 3:1.

The protrusion portion 101b can be formed into a given shape when etching conditions such as the initial shape of the photoresist pattern 120, etching time, an etching gas, applied bias, pressure in a chamber, and the substrate temperature are adjusted as appropriate.

As described in this embodiment, the current collector material 121 is etched using the photoresist pattern 120 as a mask, whereby the plurality of protrusion portions 101b extending substantially perpendicularly in the longitudinal direction can be formed. In addition, the plurality of protrusion portions 101b which have substantially the same shape and are uniform can be formed.

After the protrusion portions 101b are formed, a remaining part of the current collector material 121 except the protrusion portions 101b serves as the base portion 101a. The surface of the base portion 101a may be flat. In the case where the surface becomes rough because of the etching step, the surface area of the negative electrode active material layer 102 formed in a later step is increased, which contributes to an increase in battery capacity.

After the protrusion portions 101b are formed in the etching step, the photoresist pattern 120 used as a mask is removed in a photoresist separation step.

Next, the negative electrode current collector 101 is provided with the negative electrode active material layer 102. It is preferable that the negative electrode active material layer 102 cover an exposed surface of the negative electrode current collector 101 as illustrated in FIG. 6C. In other words, the side surfaces and top surfaces of the protrusion portions 101b and the top surface of the base portion 101a where the protrusion portions 101b are not formed are covered with the negative electrode active material layer 102.

In the case of using silicon for the negative electrode active material layer 102, the negative electrode active material layer 102 can be formed by a chemical vapor deposition (CVD) method typified by a plasma CVD method or a thermal CVD method, or a physical vapor deposition method typified by a sputtering method. As the silicon, single crystal silicon, polycrystalline silicon, amorphous silicon, or a combination thereof can be used. Alternatively, n-type silicon to which phosphorus is added or p-type silicon to which boron is added may be used as the silicon.

After that, the negative electrode active material layer 102 is isotropically etched with an ICP apparatus or the like to remove part of the negative electrode active material layer 102, whereby the negative electrode 100 in which the negative electrode active material layer 102 is provided on only the side surfaces of the protrusion portions 101b as illustrated in FIG. 2B or 2C can be formed. In the case where the etching is terminated at the time when the top surfaces of the protrusion portions 101b are exposed, the negative electrode 100 in which the negative electrode active material layer 102 remains on the entire side surfaces of the protrusion portions 101b as illustrated in FIG. 2B can be obtained. On the other hand, in the case where etching is further performed after the top surfaces of the protrusion portions 101b are exposed, the negative electrode 100 in which parts of the side surfaces of the protrusion portions 101b are exposed as illustrated in FIG. 2C can be obtained.

### (Manufacturing Method 2 of Negative Electrode)

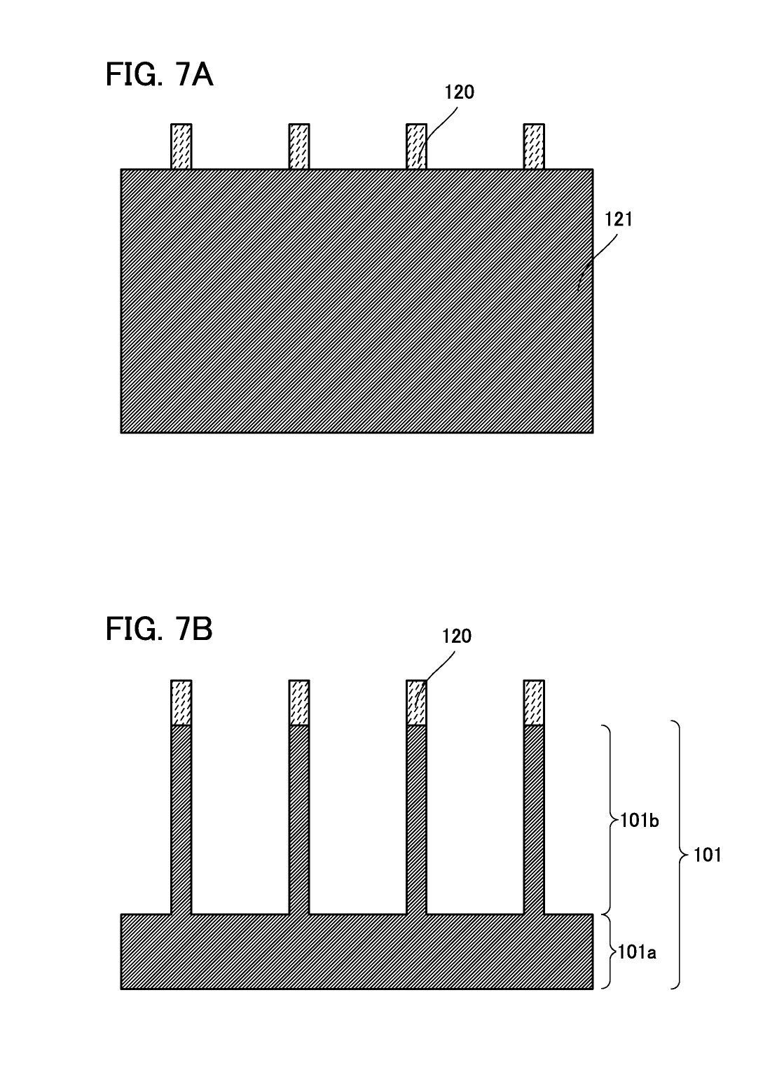

Next, a manufacturing method of the negative electrode 100 illustrated in FIGS. 3A and 3B will be described with reference to FIGS. 7A to 10B. For the same part as that in Manufacturing Method 1 of Negative Electrode, the description of Manufacturing Method 1 of Negative Electrode is referred to, as appropriate.

First, as illustrated in FIG. 7A, the photoresist pattern 120 which serves as a mask in an etching step is formed over the current collector material 121.

As the current collector material 121, the same material as that described in Manufacturing Method 1 of Negative Electrode can be used.

The photoresist pattern 120 can be formed using the same material and method as those described in Manufacturing Method 1 of Negative Electrode.

Next, the current collector material 121 is selectively etched using the photoresist pattern 120, whereby the negative electrode current collector 101 including the base portion 101a and the plurality of protrusion portions 101b is formed as illustrated in FIG. 7B. After that, the photoresist pattern 120 used as a mask is removed in a photoresist separation step.

For example, the current collector material 121 is etched by the same method as the etching method described in Manufacturing Method 1 of Negative Electrode, whereby the negative electrode current collector 101 can be formed. Further, the photoresist pattern 120 can be removed in the same step as the photoresist separation step described in Manufacturing Method 1 of Negative Electrode.

Next, the negative electrode current collector 101 is provided with the negative electrode active material layer 102.

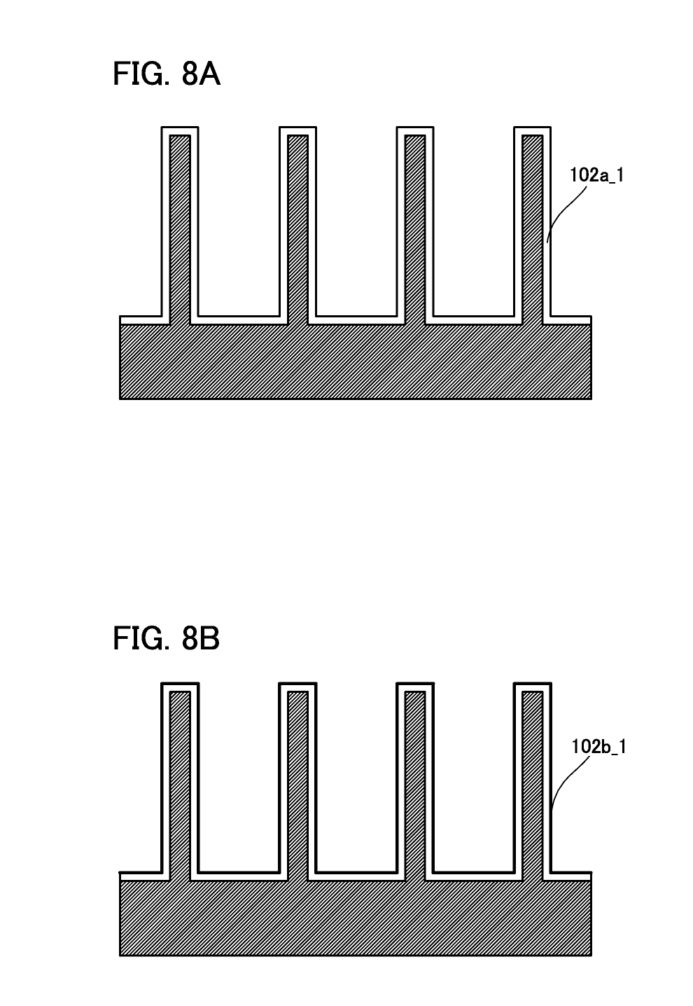

First, as illustrated in FIG. 8A, the negative electrode current collector 101 is provided with the silicon layer 102a_1.

For example, the silicon layer 102a_1 can be formed by a chemical vapor deposition (CVD) method typified by a plasma CVD method or a thermal CVD method, or a physical vapor deposition method typified by a sputtering method.

Then, as illustrated in FIG. 8B, the silicon layer 102a_1 is provided with the silicon oxide layer 102b_1.

For example, a silicon oxide film is formed by a CVD method using a deposition gas containing silicon and an oxidizing gas, whereby the silicon oxide layer 102b_1 can be formed. Examples of the deposition gas are silane, disilane, trisilane, and silane fluoride. Examples of the oxidizing gas are oxygen, ozone, dinitrogen monoxide, nitrogen dioxide, and dry air. In forming the silicon oxide film by a CVD method using a deposition gas containing silicon and an oxidizing gas, it is preferable to exercise control so that the oxidizing gas is momentarily supplied into a deposition chamber with the use of a valve or the like, in which case a thin silicon oxide film can be formed on a surface of the silicon layer 102a_1.

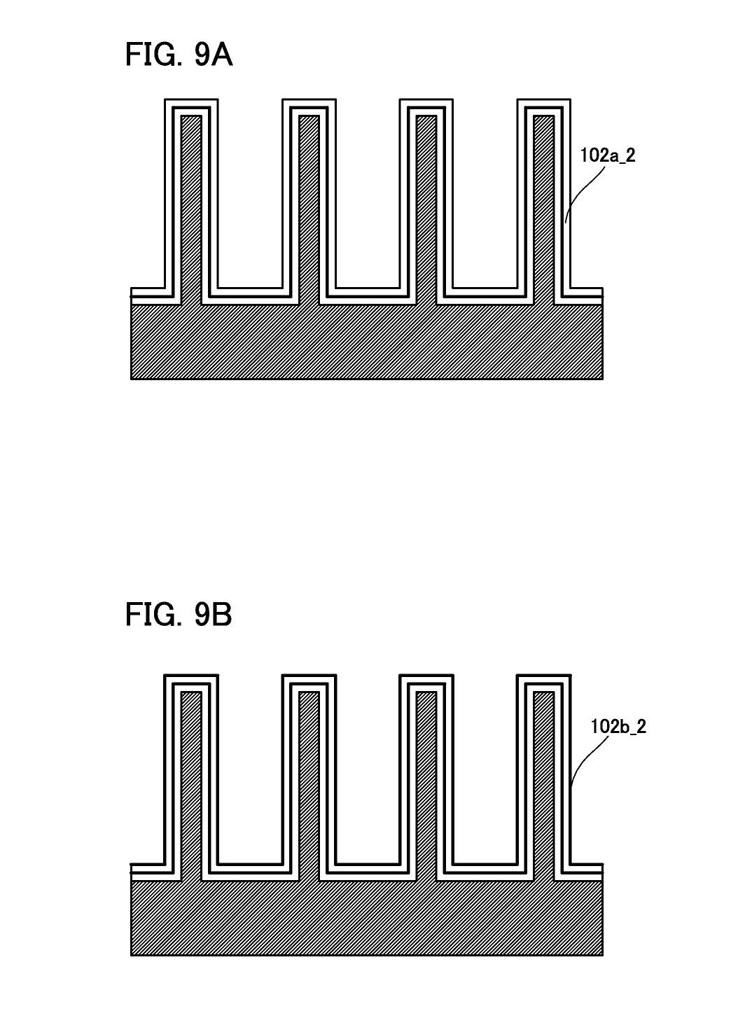

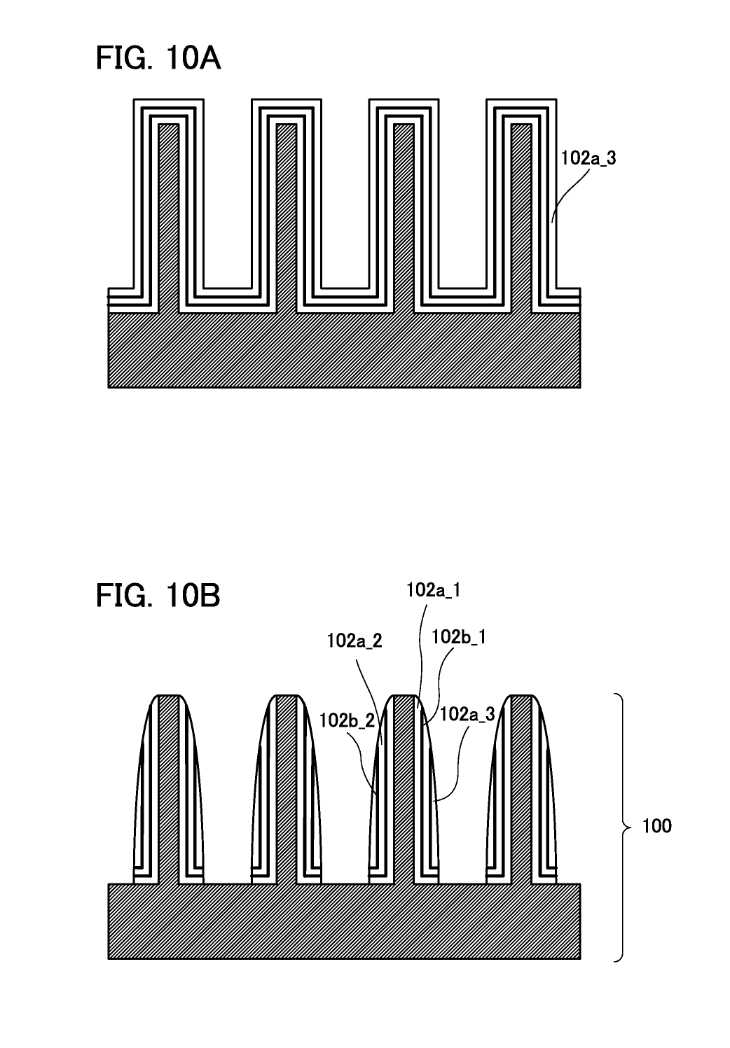

After that, the silicon oxide layer 102b_1 is provide with the silicon layer 102a_2 as illustrated in FIG. 9A. Further, the silicon layer 102a_2 is provided with the silicon oxide layer 102b_2 as illustrated in FIG. 9B. Furthermore, the silicon layer 102a3 is formed as illustrated in FIG. 10A.

The silicon layers 102a_2 and 102a_3 can be formed using the same material and method as those of the silicon layer 102a_1. The silicon oxide layer 102b_2 can be formed using the same material and method as those of the silicon oxide layer 102b_1.

Then, the stack of the silicon layer 102a_1, the silicon oxide layer 102b_1, the silicon layer 102a_2, the silicon oxide layer 102b_2, and the silicon layer 102a_3 is an isotropically etched using an ICP apparatus or the like so as to be partly removed, whereby the negative electrode 100 in which the side surfaces of the protrusion portions 101b are each provided with the silicon layer 102a_1, the silicon oxide layer 102b_1, the silicon layer 102a_2, the silicon oxide layer 102b_2, and the silicon layer 102a_3 as illustrated in FIG. 10B can be formed. By terminating the etching at the time when the top surfaces of the protrusion portions 101b are exposed, the negative electrode 100 in which the negative electrode active material layer 102 remains on the entire side surfaces of the protrusion portions 101b as illustrated in FIG. 10B can be obtained.

Such momentary introduction of the oxidizing gas is performed plural times during deposition of silicon to form the plurality of silicon oxide layers, whereby the silicon oxide layers can be formed thinner. Although descriptions are given of the case where momentary introduction of the oxidizing gas is performed twice, the number of times of momentary introduction of the oxidizing gas is not limited to two. For example, momentary introduction of the oxidizing gas may be repeated ten times, in which case ten silicon oxide layers are formed. Further, in the case of forming 100 or more silicon oxide layers for example, momentary introduction of the oxidizing gas may be repeated 100 or more times.

### (Manufacturing Method 3 of Negative Electrode)

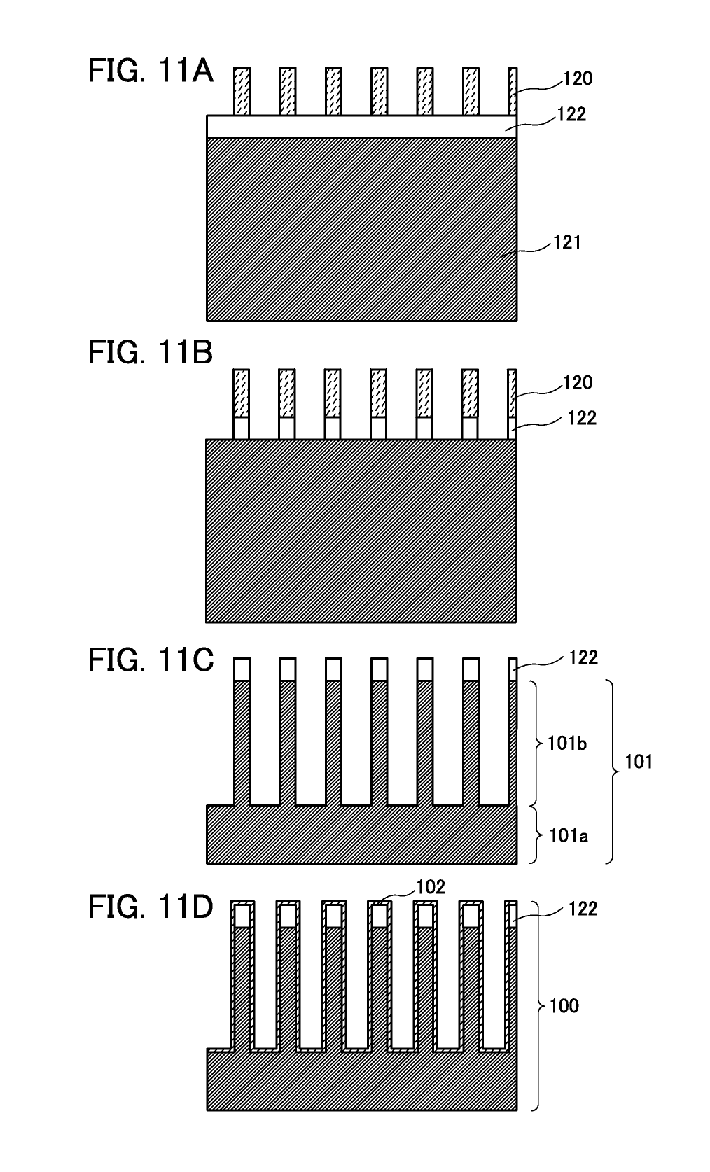

Next, a manufacturing method of the negative electrode 100 illustrated in FIG. 1B which is different from Manufacturing Method 1 of Negative Electrode will be described with reference to FIGS. 11A to 11D. This manufacturing method is different from Manufacturing Method 1 of Negative Electrode in that a protective layer is formed to be used as a hard mask for etching.

First, a protective layer 122 is formed over the current collector material 121 which is the same as that in Manufacturing Method 1 of Negative Electrode (see FIG. 11A). The protective layer 122 can be formed by a CVD method, a sputtering method, an evaporation method, a plating method, or the like. The thickness of the protective layer 122 is preferably greater than or equal to 100 nm and less than or equal to 10 μm. The protective layer 122 serves as a hard mask in an etching step and thus is preferably formed using a material which is highly resistant to etching with a gas used for etching the current collector material 121. For example, an insulator such as a silicon nitride film, a silicon oxide film, or a silicon oxynitride film can be used for the protective layer 122. When such an insulator is used for the protective layer 122, etching selectivity higher than that in the case of using a photoresist can be obtained. In the case where a material which is alloyed with lithium is selected, the protective layer 122 can be used as part of the negative electrode active material layer 102, which contributes to an increase in capacity of a lithium-ion secondary battery. Further, in the case where a material with high electric conductivity is selected, the protective layer 122 can serve as part of the protrusion portion 101b of the negative electrode current collector. Note that a material which reacts with lithium ions to cause irreversible capacity at the initial charge of a battery should not be selected for the protective layer 122.

Next, as illustrated in FIG. 11A, the photoresist pattern 120 is formed over the protective layer 122. Unlike in Manufacturing Method 1 of Negative Electrode, the photoresist pattern 120 is used to pattern the protective layer 122. The protective layer 122 is processed into a desired pattern by a dry etching method or a wet etching method using the photoresist pattern 120 as a mask (see FIG. 11B).

The photoresist pattern 120 is separated and removed with a chemical solution, and then the current collector material 121 is selectively etched using the protective layers 122 separated into individual patterns as hard masks as illustrated in FIG. 11C. Through this etching step, the base portion 101a and the protrusion portions 101b in the negative electrode current collector 101 are formed.

After that, as illustrated in FIG. 11D, the negative electrode active material layer 102 is formed so as to cover a surface of the base portion 101a which is not provided with the protrusion portions 101b, side surfaces of the protrusion portions 101b, and side surfaces and the top surfaces of the protective layers 122. The negative electrode active material layer 102 can be formed in a manner similar to that described in Manufacturing Method 1 of Negative Electrode.

The above manufacturing method allows the negative electrode 100 including the protective layers 122 to be directly formed on the protrusion portions 101b. Note that although the photoresist pattern 120 is removed at the time between the patterning of the protective layer 122 and the etching of the current collector material 121 in this manufacturing method, the photoresist pattern 120 may be removed after the current collector material 121 is etched.

In the case where the protrusion portions 101b are formed to be tall, that is, etching time is long, if only the photoresist pattern 120 is used as a mask, the thickness of the mask is gradually reduced and part of the mask is removed in the etching step, so that a surface of the current collector material 121 is exposed. This causes variations in height among the protrusion portions 101b. However, the use of the separated protective layers 122 as hard masks enables the current collector material 121 to be prevented from being exposed, so that the variations in height among the protrusion portions 101b can be reduced.

When the protective layers 122 directly on the protrusion portions 101b are formed using a conductive material, the protective layers 122 can also serve as part of the negative electrode current collector 101. In addition, when the protective layers 122 are formed using a material which is alloyed with lithium, the protective layers 122 can also serve as part of the negative electrode active material layer 102.

Moreover, the protective layers 122 directly on the protrusion portions 101b contribute to an increase in the surface area of the negative electrode active material layer 102. Particularly in the case where the protrusion portions 101b are formed to be tall, the etching time is long and there is a limitation on the height of the protrusion portions 101b that can be formed. When the protective layers 122 are formed thick in view of the above, the protrusion portions 101b on the base portion 101a can be long, which results in an increase in discharge capacity of a battery. The ratio of the height of the protrusion portion 101b formed using the current collector material 121 to the height (thickness) of the protective layer 122 can be adjusted appropriately by control of the thickness or the etching conditions. Such a free design of a ratio allows a variety of effects to be obtained. For example, the shapes of side surfaces of the protective layer 122 and the protrusion portion 101b are not necessarily the same because the protective layer 122 and the protrusion portion 101b are formed using different materials and processed in different etching steps. By taking advantage of this fact, the shape of the protrusion portion 101b can be designed appropriately. Further, depending on the position of a boundary between the protective layer 122 and the protrusion portion 101b, a protrusion structure with high mechanical strength can be formed.

### (Manufacturing Method 4 of Negative Electrode)

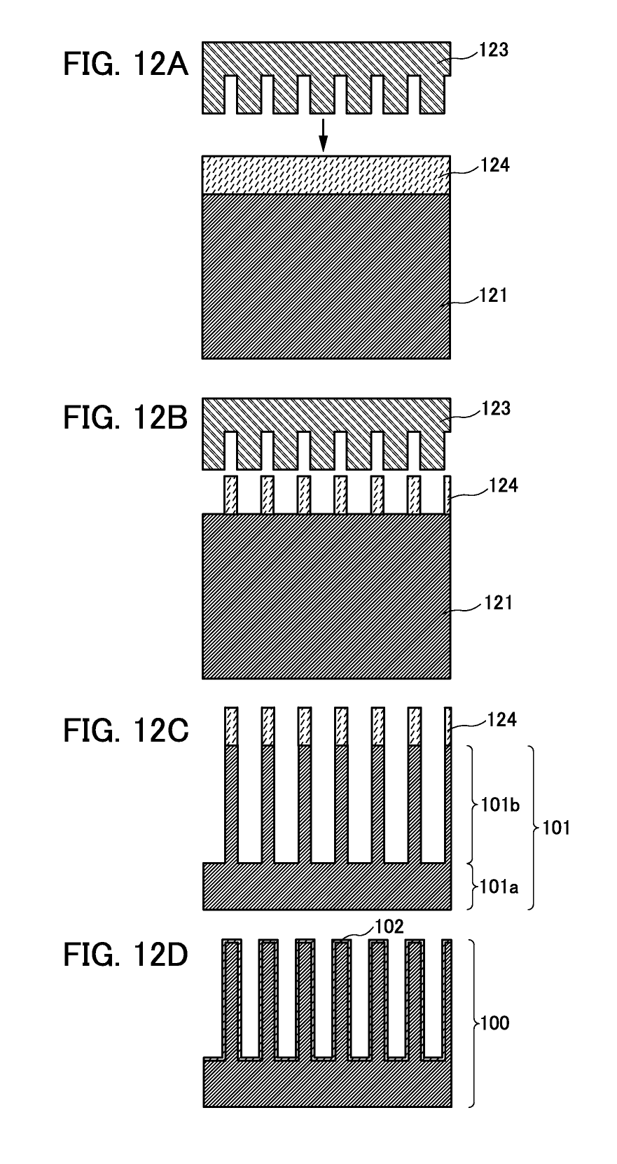

Although the negative electrode is formed using photolithography for the formation of the photoresist pattern in Manufacturing Method 1 of Negative Electrode and Manufacturing Method 2 of Negative Electrode, the negative electrode 100 illustrated in FIG. 1B is formed by a method different from the above manufacturing methods. This manufacturing method will be described with reference to FIGS. 12A to 12D. In this manufacturing method, the negative electrode current collector is formed by a nanoimprint method (nanoimprint lithography).

The nanoimprint lithography is a microfabrication technology of a wiring that was proposed by Stephen Y. Chou, a Professor of Princeton University, et al. in 1995. The nanoimprint lithography has attracted attention owing to its capability of microfabrication to a resolution of about 10 nm at low cost without a high-cost light exposure apparatus. There are thermal nanoimprint lithography and photo nanoimprint lithography in the nanoimprint lithography. A thermoplastic solid resin is used in the thermal nanoimprint lithography; a photocurable liquid resin is used in the photo nanoimprint lithography.

As illustrated in FIG. 12A, a resin 124 is applied to the current collector material 121 which is the same as that described in Manufacturing Method 1 of Negative Electrode. As the resin 124, a thermoplastic resin is used in the case of the thermal nanoimprint lithography, while a photocurable resin which is cured by ultraviolet rays is used in the case of the photo nanoimprint lithography. As the thermoplastic resin, for example, polymethylmethacrylate (PMMA) can be used. A mold 123 is pressed against the resin 124 formed over the current collector material 121 to process the resin 124 into a desired pattern. The mold 123 is obtained in the following manner: a resist is applied to a thermal silicon oxide film or the like, the resist is patterned by electron beam lithography, and the thermal silicon oxide film or the like is etched using the patterned resist as a mask.

In the case of the thermal nanoimprint lithography, a thermoplastic resin is heated to be softened before the mold 123 is pressed against the thermoplastic resin. Pressure is applied with the mold 123 in contact with the resin 124 to deform the resin 124 and cooling is performed with the pressure applied to cure the resin 124, whereby concavities and convexities of the mold 123 are transferred to the resin 124 (see FIG. 12B).

In the case of the photo nanoimprint lithography, the mold 123 is brought into contact with the resin 124 to deform the resin 124, the resin 124 in this state is irradiated with ultraviolet rays to be cured, and then the mold is detached from the resin 124, whereby projections and depressions of the mold 123 can be transferred to the resin 124 (see FIG. 12B).

In either the thermal nanoimprint lithography or the photo nanoimprint lithography, since the mold 123 is pressed against the resin 124, the resin 124 remains under the mold 123 in some cases, and in such a case, a film remains at the bottom of a depressed portion of the resin 124 which has been modified and processed. For this reason, a surface of the resin 124 is subjected to anisotropic etching (RIE) with an oxygen gas to remove the remaining film. Through the above steps, the separated resins 124 which serve as masks in an etching step are formed.

Then, in a manner similar to that in Manufacturing Method 1 of Negative Electrode, the current collector material 121 is etched using the resins 124 as masks to form the plurality of protrusion portions 101b and the base portion 101a (see FIG. 12C). Further, the negative electrode active material layer 102 is formed so as to cover the negative electrode current collector 101 (see FIG. 12D).

Through the above steps, the negative electrode current collector 101 with a microstructure can be formed without using photolithography. Particularly in this manufacturing method, an expensive light exposure apparatus and an expensive photomask are not used; thus, the negative electrode 100 can be manufactured at low cost. Moreover, a sheet-like material can be used as the current collector material 121 and a roll-to-roll method can be employed; thus, this manufacturing method is suitable for mass production of negative electrodes.

### (Manufacturing Method 5 of Negative Electrode)

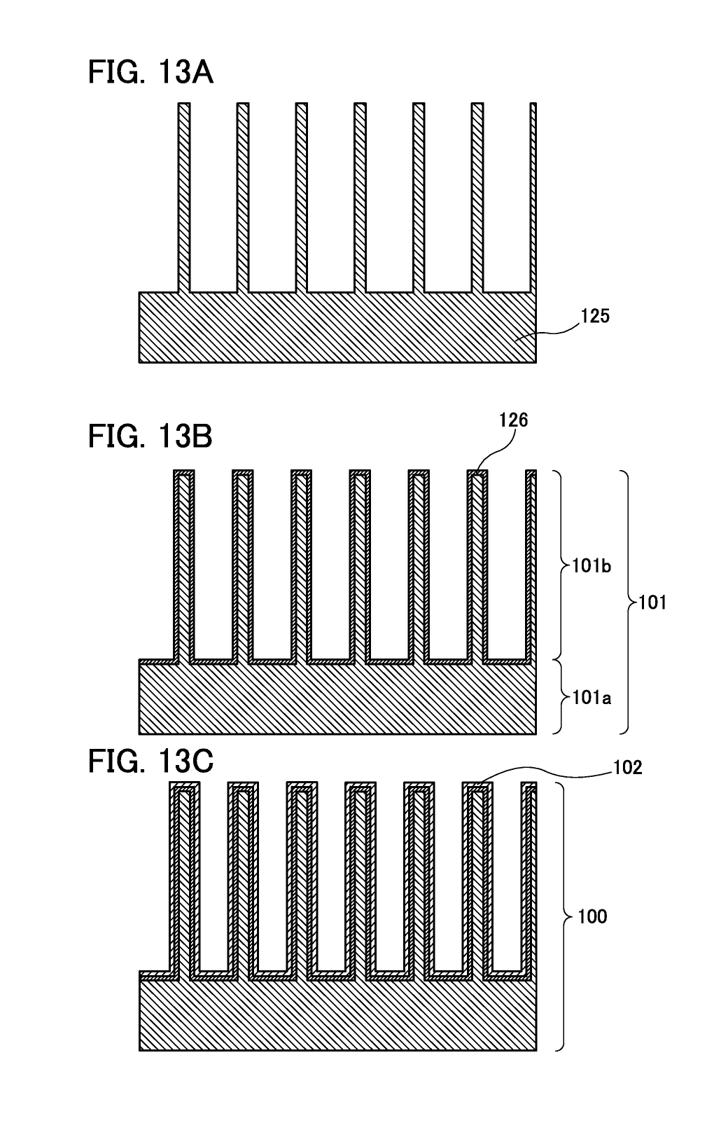

In this manufacturing method, the negative electrode 100 illustrated in FIG. 1B is manufactured by a method different from Manufacturing Methods 1 to 4 of Negative Electrodes. This manufacturing method will be described with reference to FIGS. 13A to 13C. In this manufacturing method, protrusion portions are formed on a surface of a current collector material, and then the protrusion portions are covered with a conductive layer formed using a conductive material different from the current collector material, whereby a negative electrode current collector is manufactured.

First, as illustrated in FIG. 13A, protrusion portions 101b are formed using a current collector material 125 by any of the methods described in Manufacturing Methods 1 to 4 of Negative Electrodes, and the like. Alternatively, the protrusion portions 101b may be formed by pressing. As illustrated in FIG. 13B, the protrusion portions 101b are covered with a conductive layer 126 after this step, and thus need to have a diameter determined in consideration of the thickness of the conductive layer 126 with which the protrusion portions are covered.

This manufacturing method is advantageous in that even a material which is difficult to function as a core of the negative electrode active material layer 102 can be selected as the current collector material 125 because the protrusion portions 101b are covered with the conductive layer 126. For example, copper and aluminum each have high electric conductivity and are suitable for being processed. Thus, the use of copper or aluminum allows the protrusion portions 101b to be formed by pressing. However, copper and aluminum each have high ductility and thus does not have structural strength high enough to function as a core of the negative electrode active material layer 102. Moreover, since a passivation film which is an insulator is formed on the surface of aluminum, electrode reaction does not occur even when an active material is brought into direct contact with the aluminum surface. For this reason, the conductive layer 126 is additionally formed so as to cover the current collector material 125, so that the above problems can be solved.

Even when a material which can function as a core of the negative electrode active material layer 102 is used as the current collector material 125, by covering the protrusion portions 101b with the conductive layer 126 which is formed using a hard material, mechanical strength can be further increased.

As illustrated in FIG. 13B, the conductive layer 126 is formed so as to cover a surface of the current collector material 125 where the protrusion portions 101b are formed, so that the negative electrode current collector 101 including the base portion 101a and the protrusion portions 101b is formed.

A conductive material which is not alloyed with lithium can be used for the conductive layer 126. For example, a metal typified by stainless steel, gold, platinum, silver, zinc, iron, aluminum, copper, titanium, or nickel, or an alloy thereof can be used.

The conductive layer 126 can be formed by a plating method, a sputtering method, an evaporation method, a metal organic chemical vapor deposition (MOCVD) method, or the like.

Then, as illustrated in FIG. 13C, the negative electrode active material layer 102 is formed so as to cover the conductive layer 126 by any of the methods given above. Through the above steps, the negative electrode 100 is manufactured.

In this manufacturing method, for example, the conductive layer 126 which is formed using titanium is formed on the current collector material 125 which is copper by a sputtering method, whereby the protrusion portions 101b with high strength can be formed. Thus, the protrusion portions 101b can sufficiently function as cores even when the silicon (the negative electrode active material) expands and contracts because of insertion and extraction of lithium ions; accordingly, the reliability of the negative electrode can be improved.

This embodiment can be implemented in combination with any of the other embodiments as appropriate.

### Embodiment 2

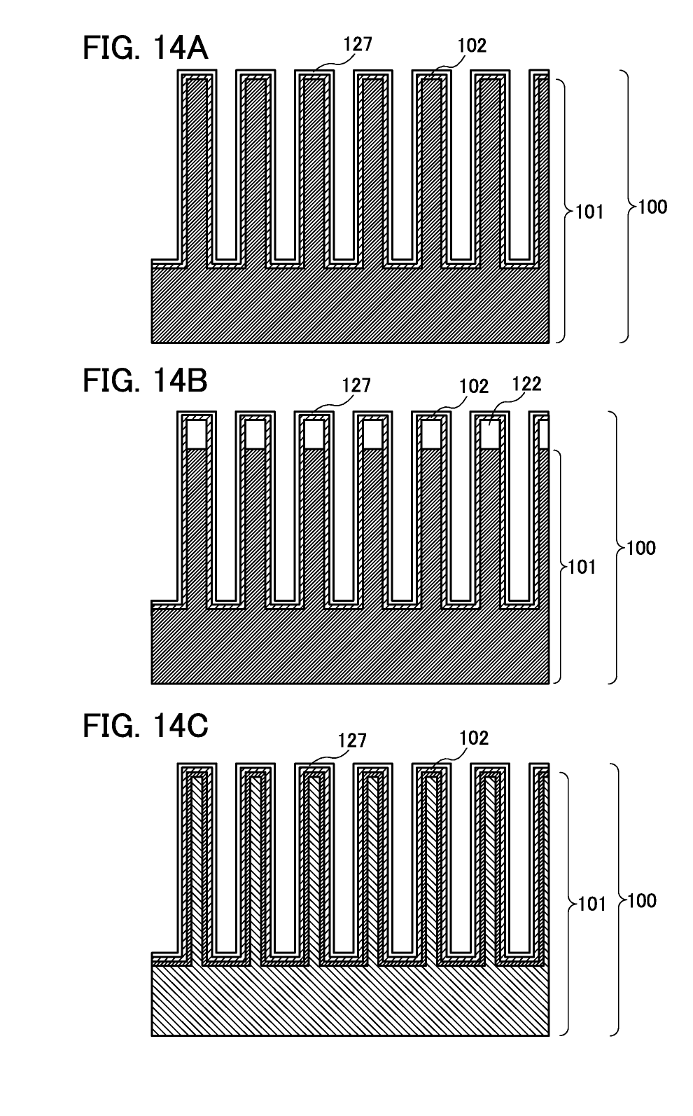

In this embodiment, a mode in which the negative electrode active material layer is provided with graphene in the negative electrode described in Embodiment 1 will be described with reference to FIGS. 14A to 14C.

### (Structure of Negative Electrode Including Graphene)

Graphene refers to a one-atom-thick sheet of carbon molecules having sp² bonds. Graphene is chemically stable, has favorable electric characteristics, and thus has been expected to be applied to channel regions of transistors, vias, wirings, and the like included in semiconductor devices; therefore, in recent years, graphene has actively been researched. In this embodiment, such graphene is used for the negative electrode described in Embodiment 1.

FIG. 14A illustrates an example in which graphene 127 is used in the negative electrode 100 which is formed by the method described in Manufacturing Method 1 of Negative Electrode or Manufacturing Method 3 of Negative Electrode in Embodiment 1, or the like. The graphene 127 is formed so as to cover the negative electrode active material layer 102 which is formed so as to cover the base portion 101a and the protrusion portions 101b of the negative electrode current collector 101. A surface of the negative electrode active material layer 102 is either entirely or partly covered with the graphene 127. For example, only the negative electrode active material layers 102 with which the side surfaces of the protrusion portions are provided may be covered with the graphene 127. The graphene, which is a sheet of carbon molecules, covers the negative electrode active material layer 102 either without a space or with spaces in places in a spot-like manner.

FIG. 14B illustrates an example in which the graphene 127 is used in the negative electrode 100 which is formed by the method described in Manufacturing Method 2 of Negative Electrode in Embodiment 1, or the like. FIG. 14B is the same as FIG. 14A except that the protective layer 122 is provided at the end of the protrusion portion 101b.

FIG. 14C illustrates an example in which the graphene 127 is used in the negative electrode 100 which is formed by the method described in Manufacturing Method 4 of Negative Electrode in Embodiment 1. FIG. 14C is the same as FIG. 14A except that the protrusion portions 101b include the current collector material 125 and the conductive layer 126.

The graphene 127 functions as a conductive additive. Further, the graphene 127 functions as an active material in some cases.

The graphene 127 includes a single-layer graphene and a multilayer graphene in its category. The graphene 127 has a sheet-like shape with a length of several micrometers.

Single-layer graphene refers to a one-atom-thick sheet of carbon molecules having sp² bonds and is very thin. Single-layer graphene contains six-membered rings each composed of carbon atoms, which are connected in the planar direction, and poly-membered rings each formed when a carbon-carbon bond in part of a six-membered ring is broken, such as a seven-membered ring, an eight-membered ring, a nine-membered ring, and a ten-membered ring.

Note that the poly-membered ring may be composed of carbon atoms and an oxygen atom. Alternatively, an oxygen atom may be bonded to a carbon atom in the poly-membered ring composed of carbon atoms. Such a poly-membered ring is formed when a carbon-carbon bond in part of a six-membered ring is broken and an oxygen atom is bonded to a carbon atom whose bond is broken. Therefore, an opening serving as a path through which ions can transfer is included in the bond of the carbon atom and the oxygen atom. That is, as the proportion of oxygen included in graphene is higher, the proportion of openings serving as paths through which ions can transfer is higher.

Note that in the case where the graphene 127 contains oxygen, the proportion of the oxygen which is measured by X-ray photoelectron spectroscopy (XPS) is greater than or equal to 2 at. % and less than or equal to 11 at. %, preferably greater than or equal to 3 at. % and less than or equal to 10 at. % of the total. As the proportion of oxygen is lower, the conductivity of the graphene can be higher. As the proportion of oxygen is increased, more openings serving as paths through which ions transfer can be formed.

In the case where the graphene 127 is multilayer graphene, the graphene 127 includes plural sheets of single-layer graphene, typically, 2 to 100 sheets of single-layer graphene and is thus very thin. Since the single-layer graphene contains oxygen, the interlayer distance between graphenes 127 is greater than or equal to 0.34 nm and less than or equal to 0.5 nm, preferably greater than or equal to 0.38 nm and less than or equal to 0.42 nm, more preferably greater than or equal to 0.39 nm and less than or equal to 0.41 nm. In general graphite, the interlayer distance between single-layer graphenes is 0.34 nm. Since the interlayer distance between the graphenes 127 is longer than the interlayer distance between single-layer graphenes in general graphite, ions can easily transfer in the direction parallel to a surface of the single-layer graphene. In addition, the graphene 127 contains oxygen and is a single-layer graphene or a multilayer graphene containing poly-membered rings and thus includes openings in places. Therefore, in the case where the graphene 127 is multilayer graphene, ions can transfer in the direction parallel to a surface of the single-layer graphene, i.e., through a gap between the single-layer graphenes, and in the direction perpendicular to a surface of the graphene, i.e., through an opening in each single-layer graphene.

Since the negative electrode active material layer 102 covers the plurality of protrusion portions 101b protruding from the base portion 101a, the surface area of the negative electrode active material layer 102 is larger than that of a plate-like (thin-film) negative electrode active material layer. Further, the plurality of protrusion portions 101b extend in the same longitudinal direction and protrude in the direction perpendicular to the base portion 101a, so that the density of the protrusion portions 101b in the negative electrode 100 can be increased and the surface area can be increased. Spaces are provided between the plurality of protrusion portions 101b, and further, the negative electrode active material layer 102 is provided with the graphene 127. Thus, even when the negative electrode active material expands on charge, contact between the protrusion portions (the protrusion portions 101b provided with the negative electrode active material layer 102) can be reduced. Moreover, even when the negative electrode active material is separated, the graphene 127 can prevent the negative electrode active material from being broken. The plurality of protrusion portions 101b have translation symmetry and are formed with high uniformity in the negative electrode 100; accordingly, in a battery including the negative electrode 100, local reaction can be reduced in each of the positive electrode and the negative electrode and carrier ions and the active material react with each other uniformly between the positive electrode and the negative electrode. Thus, in the case where the negative electrode 100 is used to fabricate a lithium-ion secondary battery, fast charge and discharge become possible and breakdown and separation of the active material on charge and discharge can be suppressed; accordingly, the lithium-ion secondary battery can have improved cycle performance. Furthermore, the shapes of the protrusion portions can be substantially the same, so that local charge and discharge can be reduced and the weight of the active material can be controlled. In addition, when the heights of the protrusion portions are substantially the same, load can be prevented from being applied locally in a manufacturing process of a battery, which results in an increase in the yield. Thus, specifications of the battery can be well controlled.

When the surface of the negative electrode active material layer 102 is comes into contact with an electrolytic solution in a lithium-ion secondary battery, the electrolytic solution and the active material react with each other, so that a film is formed on the surface of the active material. The film may be called a solid electrolyte interface which is considered necessary for relieving reaction between the negative electrode active material and the electrolytic solution, for stabilization. However, when the thickness of the film is increased, carrier ions are less likely to be received in the negative electrode active material, leading to problems such as a reduction in conductivity of carrier ions between the negative electrode active material and the electrolytic solution and a waste of the electrolytic solution.

In this embodiment, the negative electrode active material layer 102 is covered with the graphene 127.

Graphene has high conductivity; therefore, covering silicon which has lower conductivity than graphene with graphene enables sufficiently high conductivity of electrons. In addition, since graphene has a thin sheet-like shape, providing graphene so as to cover the plurality of protrusion portions can increase the amount of active material in the active material layer and facilitates transfer of carrier ions as compared with the case of graphite. As a result, the conductivity of carrier ions can be increased, reaction between silicon serving as an active material and carrier ions can be increased, and therefore, carrier ions can be easily received in the negative electrode active material. Thus, a lithium-ion secondary battery including the negative electrode can be charged and discharged at high rate.

Note that a silicon oxide layer may be provided between the negative electrode active material layer 102 and the graphene 127. When the negative electrode active material layer 102 is provided with the silicon oxide layer, ions serving as carriers are inserted in silicon oxide in charging of a lithium-ion secondary battery. As a result, a silicate compound, e.g., an alkali metal silicate such as Li₄SiO₄, Na₄SiO₄, or K₄SiO₄, an alkaline earth metal silicate such as Ca₂SiO₄, Sr₂SiO₄, or Ba₂SiO₄, Be₂SiO₄, Mg₂SiO₄, or the like is formed. Any of these silicate compounds functions as a path through which carrier ions transfer. Further, provision of the silicon oxide layer leads to suppression of expansion of the negative electrode active material layer 102. Thus, breakage of the negative electrode active material layer 102 can be suppressed while the charge and discharge capacity is maintained. In discharging after charging, not all metal ions serving as carrier ions are released from the silicate compound formed in the silicon oxide layer and part of the metal ions remain, so that the silicon oxide layer is a mixed layer of silicon oxide and the silicate compound.

The thickness of the silicon oxide layer is preferably greater than or equal to 2 nm and less than or equal to 10 nm. When the thickness of the silicon oxide layer is greater than or equal to 2 nm, expansion and contraction of the negative electrode active material layer 102 on charge and discharge can be relieved. When the thickness of the silicon oxide layer is less than or equal to 10 nm, carrier ions can transfer easily, which can prevent a reduction in discharge capacity. When the negative electrode active material layer 102 is provided with the silicon oxide layer, expansion and contraction of the negative electrode active material layer 102 in charging and discharging can be relieved, so that the negative electrode active material layer 102 can be prevented from being broken.

### (Manufacturing Method 1 of Negative Electrode Including Graphene)

Next, a manufacturing method of the negative electrode 100 will be described with reference to FIGS. 14A to 14C. As illustrated in FIGS. 14A to 14C, the negative electrode 100 can be formed in such a manner that the negative electrode current collector 101 including the base portion 101a and the plurality of protrusion portions 101b is covered with the negative electrode active material layer 102 and then the negative electrode active material layer 102 is provide with the graphene 127 as described in Embodiment 1. Here, the structure of FIG. 14A corresponds to that of FIG. 6C or FIG. 12D, the structure of FIG. 14B corresponds to that of FIG. 11D, and the structure of FIG. 14C corresponds to that of FIG. 13C.

As a method for forming the graphene 127, there are a gas phase method and a liquid phase method. In the gas phase method, after the negative electrode active material layer 102 is provided with nickel, iron, gold, copper, or an alloy containing such a metal, as a nucleus, graphene is grown from the nucleus in an atmosphere containing hydrocarbon such as methane or acetylene. In the liquid phase method, graphene oxide is provided on the surface of the negative electrode active material layer 102 using a dispersion liquid containing graphene oxide, and then, the graphene oxide is reduced to form graphene.

The dispersion liquid containing graphene oxide can be formed by a method in which graphene oxide is dispersed in a solvent, a method in which after graphite is oxidized in a solvent, graphite oxide is separated into graphene oxides to form a dispersion liquid containing graphene oxide, or the like. Here, the negative electrode active material layer 102 is provided with the graphene 127 with the use of a dispersion liquid containing graphene oxide which is formed by oxidizing graphite and then separating graphite oxide into graphene oxides.

In this manufacturing method, graphene oxide is formed by an oxidation method called a Hummers method. A Hummers method is as follows: a sulfuric acid solution of potassium permanganate or the like is mixed into graphite powder to cause oxidation reaction; thus, a mixed solution containing graphite oxide is formed. Graphite oxide contains a functional group such as an epoxy group, a carbonyl group, a carboxyl group, or a hydroxyl group because of oxidation of carbon in graphite. Accordingly, the interlayer distance between adjacent graphenes in graphite oxide is longer than the interlayer distance of graphite. Then, ultrasonic vibration is transferred to the mixed solution containing graphite oxide, so that the graphite oxide whose interlayer distance is long can be cleaved to exfoliate graphene oxide and form a dispersion liquid containing graphene oxide. Note that any other method for forming graphene oxide can be appropriately employed instead of the Hummers method.

Graphene oxide has an epoxy group, a carbonyl group, a carboxyl group, a hydroxyl group, or the like. Such a substituent has high polarity, so that graphene oxides are likely to disperse in a liquid having a polarity. In particular, since hydrogen in graphene oxide having a carbonyl group is ionized in a liquid having a polarity, the graphene oxide is ionized and different graphene oxides are more likely to disperse. Accordingly, graphene oxides disperse uniformly in a liquid having a polarity.

As a method of immersing the negative electrode active material layer 102 in the dispersion liquid containing graphene oxide to provide graphene oxide on the negative electrode active material layer 102, a coating method, a spin coating method, a dipping method, a spray method, an electrophoresis method, or the like may be employed. Alternatively, any of these methods may be combined to be employed. The electrophoresis method will be described in detail in Manufacturing Method 2 of Negative Electrode Including Graphene.

To reduce graphene oxide provided on the negative electrode active material layer 102, heating is performed at higher than or equal to 150° C., preferably higher than or equal to 300° C. and lower than or equal to the temperature at which the negative electrode active material layer 102 can withstand, in a vacuum, the air, an inert gas (nitrogen, a rare gas, or the like) atmosphere, or the like. By being heated at a higher temperature for a longer time, graphene oxide is reduced to a higher extent so that graphene with high purity (i.e., with a low concentration of elements other than carbon) can be obtained. Note that the heating temperature should be determined in consideration of reactivity between the graphene oxide and the object. Note that graphene oxide is known to be reduced at 150° C. In addition, there is also a method in which graphene oxide is immersed in a reducing solution to be reduced.

Further, when heat treatment is performed at a higher temperature and for a longer time, more defects are repaired and the conductivity is improved. In the measurements performed by the inventors, for example, graphene oxide over a glass substrate is heated and reduced to form graphene, so that the resistivity of the graphene is approximately 240 MΩ cm at a heating temperature of 100° C. (for one hour), approximately 4 kΩcm at a heating temperature of 200° C. (for one hour), and approximately 2.8 Ωcm at a heating temperature of 300° C. (for one hour). Note that each resistivity is an average value of eight samples measured by the Van der Pauw method.

Since graphite is treated with a sulfuric acid solution of potassium permanganate according to the Hummers method, a functional group such as a sulfone group also bonded to graphene oxide is released (the graphene oxide is decomposed) at a temperature higher than or equal to 200° C. and lower than or equal to 300° C., preferably higher than or equal to 200° C. and lower than or equal to 250° C. Thus, in a method for reducing graphite oxide by heating, reduction treatment of graphene oxide is preferably performed at a temperature higher than or equal to 200° C.

The conductivity of the graphene depends on the temperature of reduction treatment as described above; the same applies to its flexibility, strength, and the like. The temperature of the reduction treatment is determined in accordance with the required conductivity, flexibility, strength, and the like.

Through the above reduction treatment, the formed graphene oxide is reduced to form graphene. At this time, adjacent sheets of graphene are bonded to each other to form a larger net-like or sheet-like network. Further, through the reduction treatment, openings are formed in the graphenes because of the release of oxygen. Furthermore, the graphenes overlap with each other in parallel to a surface of a substrate. As a result, the graphenes between which carrier ions can transfer and in each of which carrier ions can transfer in openings are formed.

By this manufacturing method of a negative electrode, the negative electrode 100 illustrated in FIGS. 14A to 14C can be formed.

### (Manufacturing Method 2 of Negative Electrode Including Graphene)

Next, a manufacturing method of the negative electrode 100 in which the negative electrode active material layer 102 is provided with the graphene 127 (see FIGS. 14A to 14C), which is different from the method described in Manufacturing Method 1 of Negative Electrode Including Graphene, will be described. In this manufacturing method, the graphene 127 is formed by an electrophoresis method.

First, in a manner similar to that of the method described in Manufacturing Method 1 of Negative Electrode Including Graphene, a graphite oxide solution in which graphite oxide obtained by oxidizing graphite is dispersed is prepared. The graphite oxide is formed by a Hummers method. Ultrasonic vibration is transferred to the prepared graphite oxide solution so that the graphite oxide whose interlayer distance is long is cleaved to give the solution in which the graphene oxide is dispersed (a graphene oxide solution), and the solvent is removed, whereby the graphene oxide is obtained.

Then, the graphene oxide is dispersed in a solvent such as water or N-methylpyrrolidone (NMP), whereby a graphene oxide solution is obtained. The solvent is preferably a polar solvent. The concentration of graphene oxide may be 0.1 g to 10 g per liter. In a solution having polarity, different graphene oxides are not easily aggregated because an oxygen atom in a functional group is negatively charged. Still alternatively, a solution in which commercial graphene oxide is dispersed in a solvent or a commercial graphene oxide solution may be used. The length of one side (the flake size) of graphene oxide which is used is preferably less than or equal to 10 μm.

Next, the graphene oxide solution is applied to the negative electrode active material layer 102 in the negative electrode 100 described in Embodiment 1. In the case where the graphene oxide is formed on an active material which has a complicated curved surface or unevenness like the negative electrode active material layer 102 with which the plurality of protrusion portions 101b are provided, it is particularly preferable to employ an electrophoresis method. Here, the case of employing an electrophoresis method will be described below.

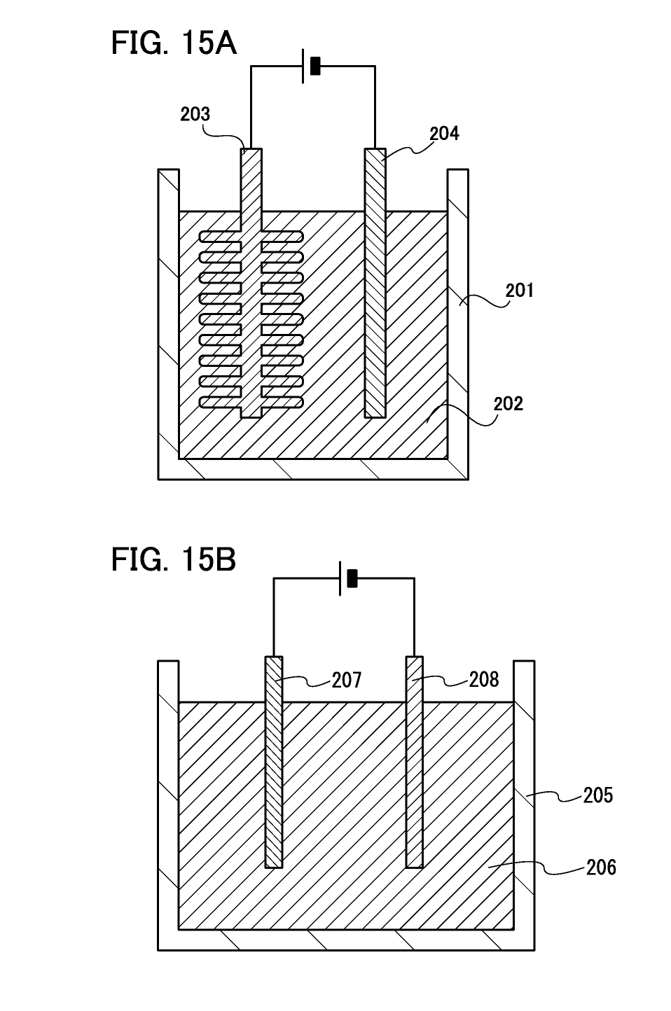

FIG. 15A is a cross-sectional view illustrating an electrophoresis method. In a container 201, the solution in which graphene oxide is dispersed and which is obtained by the above method (hereinafter referred to as a graphene oxide solution 202) is contained. Further, a subject 203 on which graphene oxide is to be formed is put in the graphene oxide solution 202 and is used as an anode. In addition, a conductor 204 serving as a cathode is put in the graphene oxide solution 202. Note that the subject 203 is the negative electrode current collector 101 and the negative electrode active material layer 102 with which the negative electrode current collector 101 is provided. As the conductor 204, a conductive material such as a metal material or an alloy material is used.

When an appropriate voltage is applied between the anode and the cathode, a graphene oxide layer is formed on a surface of the subject 203, that is, the surface of the negative electrode active material layer 102 formed so as to cover the base portion 101a and the plurality of protrusion portions 101b of the current collector. Since the graphene oxide is negatively charged in a polar solvent as described above, when a voltage is applied, the negatively charged graphene oxide is attracted to the anode and deposited on the subject 203. The reason why the graphene oxide is negatively charged is that hydrogen ions are released from a substituent such as an epoxy group or a carboxyl group in the graphene oxide; therefore, when the substituent is bonded to an object, neutralization is accomplished. Note that the voltage which is applied does not necessarily have to be constant. Further, by measuring the amount of charge flowing between the anode and the cathode, the thickness of a graphene oxide layer deposited on the object can be estimated.

The voltage applied between the cathode and the anode is preferably in the range of 0.5 V to 2.0 V, more preferably in the range of 0.8 V to 1.5 V. For example, when the voltage applied between the anode and the cathode is set to 1 V, an oxide film which might be generated based on the principle of anodic oxidation is not easily formed between the subject 203 and the graphene oxide layer.

When the graphene oxide layer with a required thickness is obtained, the subject 203 is taken out of the graphene oxide solution 202 and dried.

In electrodeposition of graphene oxide by an electrophoresis method, further graphene oxide is scarcely stacked on a portion which is already covered with graphene oxide. This is because the conductivity of graphene oxide is sufficiently low. On the other hand, graphene oxide is preferentially stacked on a portion which is not covered yet with graphene oxide. Therefore, the thickness of the graphene oxide formed on the surface of the subject 203 is practically uniform.

Time for performing electrophoresis (time for applying a voltage) is preferably longer than time for covering the surface of the subject 203 with the graphene oxide, for example, longer than or equal to 0.5 minutes and shorter than or equal to 30 minutes, more preferably longer than or equal to 5 minutes and shorter than or equal to 20 minutes.

An electrophoresis method enables ionized graphene oxide to be electrically transferred to an active material, so that graphene oxide can be provided also in a region where the base portion 101a is in contact with the plurality of protrusion portions 101b (i.e., basal portions of the protrusion portions). Therefore, graphene oxide can be provided uniformly on surfaces of the base portion 101a and the protrusion portions 101b even when the protrusion portions 101b are high. However, the distance between adjacent protrusion portions 101b of the plurality of protrusion portions 101b and the flake size of the graphene oxide need to be determined with attention so that the graphene oxide can enter the space between the adjacent protrusion portions 101b.

Then, part of oxygen is released from the graphene oxide by reduction treatment. Although, as the reduction treatment, thermal reduction treatment or the like, which is described in Manufacturing Method 1 of Negative Electrode Including Graphene, may be performed, electrochemical reduction treatment will be described here.

The electrochemical reduction of graphene oxide is reduction utilizing electric energy, which is different from reduction by heat treatment. As illustrated in FIG. 15B, a closed circuit is formed using, as a conductor 207, the negative electrode 100 including graphene oxide provided on the negative electrode active material layer 102, and a potential at which the reduction reaction of the graphene oxide occurs or a potential at which the graphene oxide is reduced is supplied to the conductor 207, so that the graphene oxide is reduced to form graphene. Note that in this specification, a potential at which the reduction reaction of the graphene oxide occurs or a potential at which the graphene oxide is reduced is referred to as the reduction potential.

A method for reducing the graphene oxide will be specifically described with reference to FIG. 15B. A container 205 is filled with an electrolytic solution 206, and a counter electrode 208 and the conductor 207 provided with the graphene oxide are put in the container so as to be immersed in the electrolytic solution 206. Next, an electrochemical cell (open circuit) is formed with the use of at least the counter electrode 208 and the electrolytic solution 206 besides the conductor 207 provided with the graphene oxide as a working electrode, and the reduction potential of the graphene oxide is supplied to the conductor 207 (working electrode), so that the graphene oxide is reduced to form graphene. Note that the reduction potential to be supplied is a reduction potential in the case where the potential of the counter electrode 208 is used as a reference potential or a reduction potential in the case where a reference electrode is provided in the electrochemical cell and the potential of the reference electrode is used as a reference potential. For example, when the counter electrode 208 and the reference electrode are each made of a lithium metal, the reduction potential to be supplied is a reduction potential determined relative to the redox potential of the lithium metal (vs. Li/Li⁺). This process allows reduction current to flow through the electrochemical cell (closed circuit) when the graphene oxide is reduced. Thus, to examine whether the graphene oxide is reduced, the reduction current needs to be checked continuously; the state where the reduction current is below a certain value (where there is no peak corresponding to the reduction current) is regarded as the state where the graphene oxide has been reduced (where the reduction reaction is completed).

In controlling the potential of the conductor 207, the potential of the conductor 207 may be fixed to the reduction potential of the graphene oxide or may be swept so as to include the reduction potential of the graphene oxide. Further, the sweeping may be repeated at intervals as in cyclic voltammetry. Although there is no limitation on the sweep rate of the potential of the conductor 207, it is preferably higher than or equal to 0.005 mV/s and lower than or equal to 1 mV/s. Note that the potential of the conductor 207 may be swept either from a higher potential to a lower potential or from a lower potential to a higher potential.

Although the reduction potential of the graphene oxide slightly varies depending on the structure of the graphene oxide (e.g., the presence or absence of a functional group and formation of graphene oxide salt) and the way to control the potential (e.g., the sweep rate), it is approximately 2.0 V (vs. Li/Li⁺). Specifically, the potential of the conductor 207 should be controlled so as to fall within the range of 1.6 V to 2.4 V (vs. Li/Li⁺).

Through the above steps, the graphene 127 can be formed on the conductor 207. In the case where electrochemical reduction treatment is performed, the proportion of C(sp²)-C(sp²) double bonds is higher than that of graphene formed by heat treatment; therefore, the negative electrode active material layer 102 can be provided with the graphene 127 having high conductivity.

Note that only the graphene 127 which is over the top surfaces of the protrusion portions 101b may be removed by oxygen plasma treatment in order to form a spacer which will be described later.

By this manufacturing method of a negative electrode, the negative electrode 100 illustrated in FIGS. 14A to 14C can be formed.

This embodiment can be implemented in combination with any of the other embodiments as appropriate.

### Embodiment 3

In this embodiment, the structure and manufacturing method of a lithium-ion secondary battery will be described.

First, a positive electrode and a manufacturing method thereof will be described.

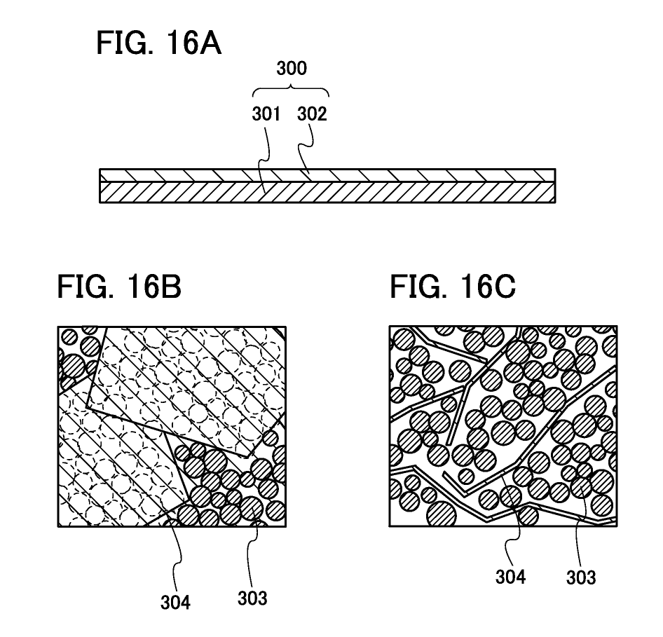

FIG. 16A is a cross-sectional view of a positive electrode 300. In the positive electrode 300, a positive electrode current collector 301 is provided with a positive electrode active material layer 302.

For the positive electrode current collector 301, a highly conductive material such as a metal typified by stainless steel, gold, platinum, zinc, iron, copper, aluminum, or titanium, or an alloy thereof can be used. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The positive electrode current collector 301 can have a foil-like shape, a plate-like shape (sheet-like shape), a net-like shape, a punching-metal shape, an expanded-metal shape, or the like as appropriate.

The positive electrode active material layer 302 can be formed using a compound such as LiFeO₂, LiCoO₂, LiNiO₂, LiMn₂O₄, V₂O₅, Cr₂O₅, or MnO₂ as a material.

Alternatively, a lithium-containing complex phosphate (LiMPO₄ (general formula) (M is one or more of Fe(II), Mn(II), Co(II), and Ni(II))) can be used for the positive electrode active material layer 302. Typical examples of LiMPO₄ (general formula) are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<<1).

Alternatively, a lithium-containing complex silicate expressed by Li₍₂₋ⱼ₎MSiO₄ (general formula) (M is one or more of Fe(II), Mn(II), Co(II), and Ni(II), 0≦j≦2) can be used for the positive electrode active material layer 302. Typical examples of Li₍₂₋ⱼ₎MSiO₄ (general formula) are Li₍₂₋ⱼ₎FeSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗ/SiO₄, Li₍₂₋ⱼ₎FeₖMnₗSiO₄, L₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{g}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

In the case where carrier ions are alkali metal ions other than lithium ions, alkaline-earth metal ions, beryllium ions, or magnesium ions, the following may be used for the positive electrode active material layer 302: a complex material obtained by substituting an alkali metal (e.g., sodium or potassium), an alkaline-earth metal (e.g., calcium, strontium, barium, beryllium, or magnesium) for lithium in the lithium compound, the lithium-containing complex phosphate, or the lithium-containing complex silicate.

The positive electrode active material layer 302 is not necessarily formed in direct contact with the top surface of the positive electrode current collector 301. Any of the following functional layers may be formed, using a conductive material such as a metal, between the positive electrode current collector 301 and the positive electrode active material layer 302: an adhesion layer for increasing the adhesion between the positive electrode current collector 301 and the positive electrode active material layer 302; a planarization layer for reducing the roughness of the surface of the positive electrode current collector 301; a heat radiation layer; a stress relaxation layer for reducing the stress on the positive electrode current collector 301 or the positive electrode active material layer 302; and the like.

FIG. 16B is a plan view of the positive electrode active material layer 302 including positive electrode active material particles 303 capable of receiving and releasing carrier ions, and graphenes 304 which cover a plurality of the positive electrode active material particles 303 and at least partly surround the plurality of the positive electrode active material particles 303. The different graphenes 304 cover surfaces of a plurality of the positive electrode active material particles 303. The positive electrode active material particles 303 may partly be exposed.

The size of the positive electrode active material particle 303 is preferably greater than or equal to 20 nm and less than or equal to 100 nm. Note that the size of the positive electrode active material particle 303 is preferably smaller because electrons transfer in the positive electrode active material particles 303.

Sufficient characteristics can be obtained even when surfaces of the positive electrode active material particles 303 are not covered with graphite layers; however, it is preferable to use both the graphene and the positive electrode active material particles 303 covered with graphite layers because current flows.

FIG. 16C is a cross-sectional view of a part of the positive electrode active material layer 302 in FIG. 16B. The positive electrode active material layer 302 includes the positive electrode active material particles 303 and the graphenes 304 which cover a plurality of the positive electrode active material particles 303. The graphenes 304 are observed to have linear shapes in the cross-sectional view. A plurality of the positive electrode active material particles 303 are at least partly surrounded with one or a plurality of the graphenes 304 or sandwiched between a plurality of the graphenes 304. Note that the graphene has a bag-like shape, and a plurality of the positive electrode active material particles 303 are surrounded with the graphene in some cases. In addition, part of the positive electrode active material particles 303 is not covered with the graphenes 304 and exposed in some cases.

The desired thickness of the positive electrode active material layer 302 is determined to be greater than or equal to 20 μm and less than or equal to 100 μm. It is preferable to adjust the thickness of the positive electrode active material layer 302 as appropriate so that neither a crack nor flaking is caused.

Note that the positive electrode active material layer 302 may include acetylene black particles having a volume 0.1 times to 10 times as large as that of the graphene 304, carbon particles having a one-dimensional expansion such as carbon nanofibers, or other known conductive additives.

An example of the positive electrode active material particle 303 is a material whose volume is expanded by reception of ions serving as carriers. When such a material is used, the positive electrode active material layer 302 gets vulnerable and is partly collapsed on charge and discharge, resulting in lower reliability of a battery. However, the graphene covering the periphery of the positive electrode active material particles 303 can prevent dispersion of the positive electrode active material particles 303 and the collapse of the positive electrode active material layer 302, even when the volume of the positive electrode active material particles 303 is increased and decreased on charge and discharge. That is to say, the graphene 304 has a function of maintaining the bond between the positive electrode active material particles 303 even when the volume of the positive electrode active material particles 303 is increased and decreased on charge and discharge.

The graphene 304 is in contact with a plurality of the positive electrode active material particles 303 and serves also as a conductive additive. Further, the graphene 304 has a function of holding the positive electrode active material particles 303 capable of receiving and releasing carrier ions. Thus, a binder does not have to be mixed into the positive electrode active material layer 302. Accordingly, the proportion of the positive electrode active material particles 303 in the positive electrode active material layer 302 can be increased, which allows an increase in charge and discharge capacity of a lithium-ion secondary battery.

Next, a method for forming the positive electrode active material layer 302 will be described.

Slurry containing the positive electrode active material particles 303 and graphene oxide is formed. Then, the slurry is applied to the positive electrode current collector 301. After that, as in the formation method of graphene, which is described in Embodiment 2, heating in a reducing atmosphere is performed for reduction treatment so that the positive electrode active material particles 303 are baked and part of oxygen is released from the graphene oxide to form openings in the graphene 304. Note that oxygen in the graphene oxide is not entirely released and partly remains in the graphene 304. Through the above steps, the positive electrode current collector 301 can be provided with the positive electrode active material layer 302. Consequently, the positive electrode active material layer 302 has higher conductivity.

Graphene oxide contains oxygen and thus is negatively charged in a polar solvent. As a result of being negatively charged, graphene oxide is dispersed. Accordingly, the positive electrode active material particles 303 contained in the slurry are not easily aggregated, so that the size of the positive electrode active material particle 303 can be prevented from increasing. Thus, the transfer of electrons in the positive electrode active material particles 303 is facilitated, resulting in an increase in conductivity of the positive electrode active material layer 302.

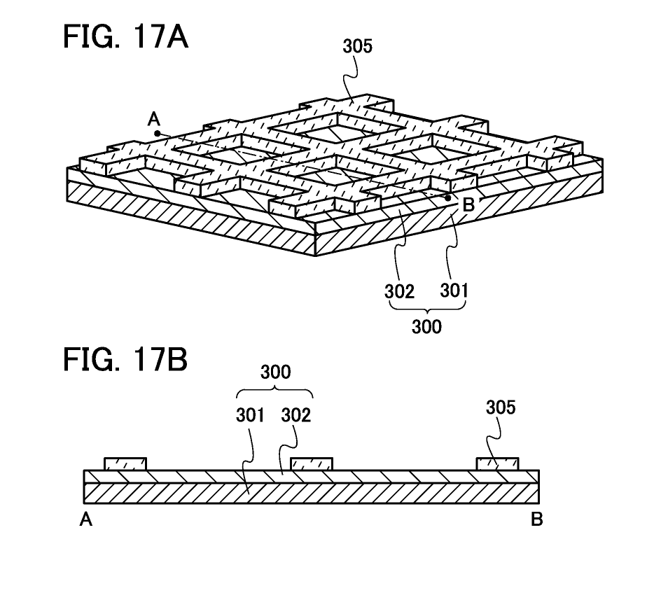

FIGS. 17A and 17B illustrate an example in which a spacer 305 is provided on a surface of the positive electrode 300. FIG. 17A is a perspective view of the positive electrode including the spacer, and FIG. 17B is a cross-sectional view taken along dashed dotted line A-B in FIG. 17A.

As illustrated in FIGS. 17A and 17B, in the positive electrode 300, the positive electrode current collector 301 is provided with the positive electrode active material layer 302. Further, the spacer 305 is provided on the positive electrode active material layer 302.

The spacer 305 can be formed using a material which has an insulating property and does not react with an electrolyte. Specifically, an organic material such as an acrylic resin, an epoxy resin, a silicone resin, polyimide, or polyamide, or low-melting-point glass such as glass paste, glass frit, or glass ribbon can be used.

The spacer 305 can be formed by a printing method such as screen printing, an inkjet method, or the like. Thus, the spacer 305 can be formed into any shape.

The spacer 305 is substantially evenly formed in a thin film form directly on the positive electrode active material layer 302, and has a plurality of openings each with a shape such as a rectangle, a polygon, or a circle. The planar shape of the spacer 305 can be a lattice-like shape, a closed circular or polygonal loop shape, a porous shape, or the like. Alternatively, a plurality of the spacers 305 may extend linearly to be arranged in stripes. The positive electrode active material layer 302 is partly exposed from the plurality of openings of the spacer 305. Thus, the spacer 305 prevents contact between a positive electrode and a negative electrode and also ensures the transfer of carrier ions between the positive electrode and the negative electrode through the plurality of openings.

The thickness of the spacer 305 is preferably greater than or equal to 1 μm and less than or equal to 5 μm, more preferably greater than or equal to 2 μm and less than or equal to 3 μm. Therefore, the distance between the positive electrode and the negative electrode and the travel distance of carrier ions between the positive electrode and the negative electrode can be shorter than those of a conventional lithium-ion secondary battery in which a separator having a thickness of several tens of micrometers is provided between a positive electrode and a negative electrode. Accordingly, carrier ions included in a lithium-ion secondary battery can be effectively used for charge and discharge.

Thus, the spacer 305 renders a separator in a lithium-ion secondary battery unnecessary. As a result, the number of components of a lithium-ion secondary battery and the cost can be reduced.

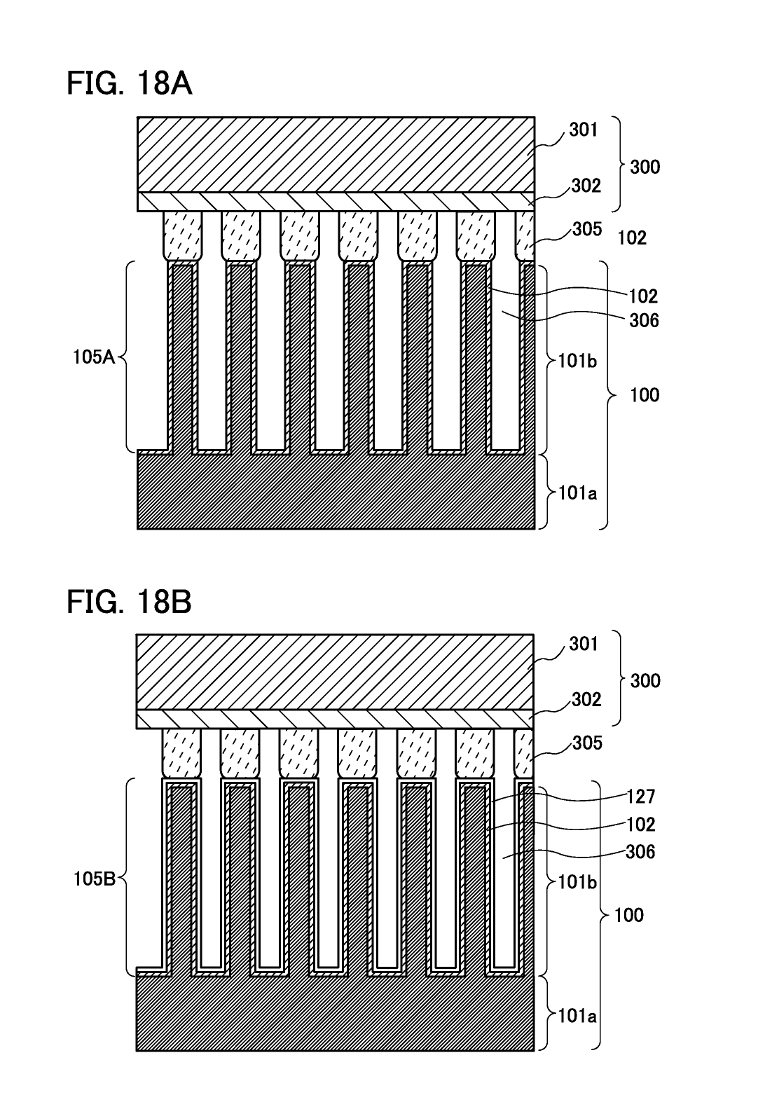

FIGS. 18A and 18B illustrate an example of a separator-less lithium-ion secondary battery including the spacer 305. FIG. 18A illustrates a battery assembled using the negative electrode 100 formed as described above and the above positive electrode 300. The spacer 305 is interposed between the negative electrode 100 and the positive electrode 300, and spaces made by the negative electrode 100, the positive electrode 300, and the spacer 305 are filled with an electrolytic solution 306. The shapes of protrusion portions 105A (specifically, the protrusion portions 101b provided with the negative electrode active material layer 102) of the negative electrode 100 and the spacer 305 are designed so that the protrusion portions of the negative electrode 100 are in contact with the spacer 305. The protrusion portions and the spacer 305 preferably make surface contact with each other in order to maintain the mechanical strength. Thus, a surface of the spacer 305 and the surfaces of the protrusion portions 101b of the negative electrode 100 which make contact with each other are preferably as flat as possible.

FIG. 18B illustrates an example of a separator-less lithium-ion secondary battery including the negative electrode 100 formed using the graphene 127. Although protrusion portions 105B of the negative electrode 100 in FIG. 18B differ from the protrusion portions 105A in FIG. 18A in that the graphene 127 is provided, the shape and structure of the protrusion portions 105B are the same as those of the protrusion portions 105A.

Note that although all the protrusion portions 105A/105B are in contact with and the spacer 305 in FIG. 13A/FIG. 13B, all the protrusion portions 105A/105B do not need to make contact with the spacer 305. That is, there is no problem even if part of the plurality of protrusion portions 105A/105B of the negative electrode 100 is placed in a position facing the openings in the spacer 305.

As well as the spacer 305, the protrusion portions 105A/105B of the negative electrode 100, which are in contact with the spacer 305, have a function of keeping a distance between the positive electrode 300 and the negative electrode 100. Thus, it is important that the protrusion portions 105A and 105B have sufficient mechanical strength. Therefore, an extremely significant structure can be obtained when a current collector material which forms the protrusion portions 105A is used as a core (101b) of the negative electrode active material layer 102, and titanium whose strength is higher than that of copper or the like is used as the current collector material.

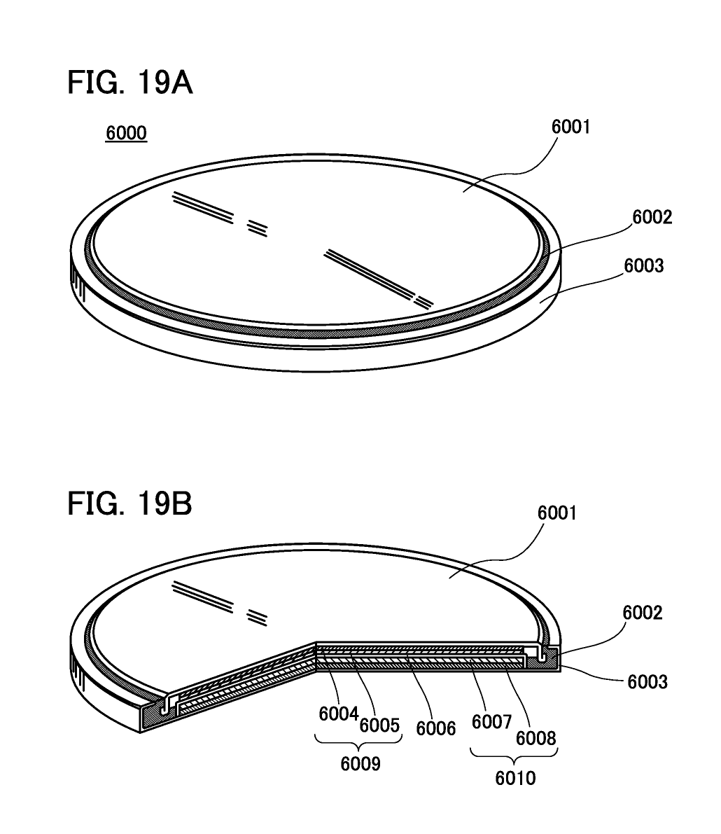

Next, a structure and a manufacturing method of the lithium-ion secondary battery will be described with reference to FIGS. 19A and 19B. Here, a cross-sectional structure of the lithium-ion secondary battery will be described below.

FIG. 19A is an external view of a coin-type (single-layer and flat) lithium-ion secondary battery, and FIG. 19B is a cross-sectional view thereof.

In a coin-type lithium-ion secondary battery 6000, a positive electrode can 6003 doubling as a positive electrode terminal and a negative electrode can 6001 doubling as a negative electrode terminal are insulated from each other and sealed by a gasket 6002 made of polypropylene or the like. As in the above description, a positive electrode 6010 includes a positive electrode current collector 6008 and a positive electrode active material layer 6007 provided in contact with the positive electrode current collector 6008. A negative electrode 6009 includes a negative electrode current collector 6004 and a negative electrode active material layer 6005 provided in contact with the negative electrode current collector 6004. A separator 6006 and an electrolyte (not illustrated) are provided between the positive electrode active material layer 6007 and the negative electrode active material layer 6005. In the positive electrode 6010, a positive electrode active material layer which is obtained through the above process is used as the positive electrode active material layer 6007.

The negative electrode 100 described in Embodiment 1 or 2 is used as appropriate as the negative electrode 6009.

As the positive electrode current collector 6008 and the positive electrode active material layer 6007, the positive electrode current collector 301 and the positive electrode active material layer 302, which are described in this embodiment, can be used as appropriate.

As the separator 6006, an insulator such as cellulose (paper), or polyethylene or polypropylene with pores can be used.

Note that in the case where a positive electrode provided with the spacer 305 in FIGS. 17A and 17B, which is described above, is used as the positive electrode 6010, the separator 6006 does not necessarily have to be provided.

As a solute of the electrolyte, a material which contains carrier ions is used. Typical examples of the solute of the electrolyte include lithium salts such as LiClO₄, LiAsF₆, LiBF₄, LiPF₆, and Li(C₂F₅SO₂)₂N.

Note that when carrier ions are alkali metal ions other than lithium ions or alkaline-earth metal ions, instead of lithium in the above lithium salts, an alkali metal (e.g., sodium or potassium), an alkaline-earth metal (e.g., calcium, strontium, barium, beryllium, or magnesium) may be used for a solute of the electrolyte.

As a solvent of the electrolyte, a material in which carrier ions can transfer is used. As the solvent of the electrolyte, an aprotic organic solvent is preferably used. Typical examples of aprotic organic solvents include ethylene carbonate (EC), propylene carbonate, dimethyl carbonate, diethyl carbonate (DEC), γ-butyrolactone, acetonitrile, dimethoxyethane, tetrahydrofuran, and the like, and one or more of these materials can be used. When a gelled high-molecular material is used as the solvent of the electrolyte, safety against liquid leakage and the like is improved. Further, the lithium-ion secondary battery can be thinner and more lightweight. Typical examples of gelled high-molecular materials include a silicone gel, an acrylic gel, an acrylonitrile gel, polyethylene oxide, polypropylene oxide, a fluorine-based polymer, and the like. Alternatively, the use of one or more of ionic liquids (room temperature molten salts) which have features of non-flammability and non-volatility as a solvent of the electrolyte can prevent a lithium-ion secondary battery from exploding or catching fire even when the secondary battery internally shorts out or the internal temperature increases owing to overcharging or the like.

As the electrolyte, a solid electrolyte including an inorganic material such as a sulfide-based inorganic material or an oxide-based inorganic material, or a solid electrolyte including a macromolecular material such as a polyethylene oxide (PEO)-based macromolecular material may alternatively be used. When the solid electrolyte is used, a separator or a spacer is not necessary. Further, the battery can be entirely solidified; therefore, there is no possibility of liquid leakage and thus the safety of the battery is dramatically increased.

For the positive electrode can 6003 and the negative electrode can 6001, a metal having corrosion resistance to an electrolytic solution, such as nickel, aluminum, or titanium, an alloy of such a metal, or an alloy of such a metal and another metal (stainless steel or the like) can be used. Further, it is preferable to cover the metal or the like with nickel, aluminum, or the like in order to prevent corrosion by the electrolytic solution. The positive electrode can 6003 and the negative electrode can 6001 are electrically connected to the positive electrode 6010 and the negative electrode 6009, respectively.

The negative electrode 6009, the positive electrode 6010, and the separator 6006 are immersed in the electrolyte. Then, as illustrated in FIG. 19B, the positive electrode 6010, the separator 6006, the negative electrode 6009, and the negative electrode can 6001 are stacked in this order with the positive electrode can 6003 positioned at the bottom, and the positive electrode can 6003 and the negative electrode can 6001 are subjected to pressure bonding with the gasket 6002 interposed therebetween. In such a manner, the coin-type lithium-ion secondary battery 6000 is manufactured.

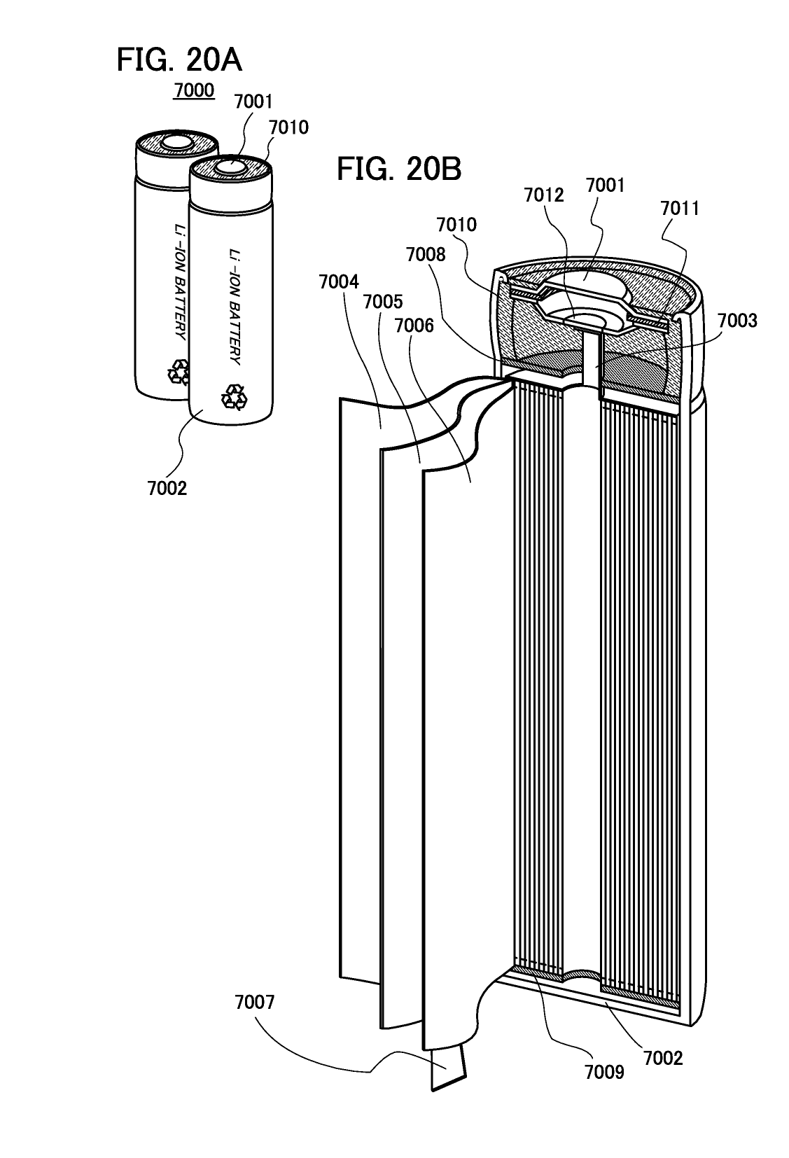

Next, a structure of a cylindrical lithium-ion secondary battery will be described with reference to FIGS. 20A and 20B. As illustrated in FIG. 20A, a cylindrical lithium-ion secondary battery 7000 includes a positive electrode cap (battery cap) 7001 on the top surface and a battery can (outer can) 7002 on the side surface and bottom surface. The positive electrode cap 7001 and the battery can 7002 are insulated from each other by a gasket 7010 (insulating gasket).

FIG. 20B is a diagram schematically illustrating a cross section of the cylindrical lithium-ion secondary battery. Inside the battery can 7002 having a hollow cylindrical shape, a battery element in which a strip-like positive electrode 7004 and a strip-like negative electrode 7006 are wound with a stripe-like separator 7005 interposed therebetween is provided. Although not illustrated, the battery element is wound around a center pin. One end of the battery can 7002 is close and the other end thereof is open. For the battery can 7002, a metal having corrosion resistance to an electrolytic solution, such as nickel, aluminum, or titanium, an alloy of such a metal, or an alloy of such a metal and another metal (stainless steel or the like) can be used. Further, it is preferable to cover the metal or the like with nickel, aluminum, or the like in order to prevent corrosion by the electrolytic solution. Inside the battery can 7002, the battery element in which the positive electrode, the negative electrode, and the separator are wound is interposed between a pair of insulating plates 7008 and 7009 which face each other. Further, an electrolyte (not illustrated) is injected inside the battery can 7002 provided with the battery element. As the electrolyte, an electrolyte which is similar to that of the above coin-type lithium-ion secondary battery can be used.

Although the positive electrode 7004 and the negative electrode 7006 can be formed in a manner similar to that of the positive electrode 6010 and the negative electrode 6009 of the coin-type lithium-ion secondary battery 6000 described above, the difference lies in that, since the positive electrode and the negative electrode of the cylindrical lithium-ion secondary battery are wound, active materials are formed on both sides of the current collectors. The use of the negative electrode described in Embodiment 1 or 2 for the negative electrode 7006 enables the lithium-ion secondary battery with high capacity to be manufactured. A positive electrode terminal (positive electrode current collecting lead) 7003 is connected to the positive electrode 7004, and a negative electrode terminal (negative electrode current collecting lead) 7007 is connected to the negative electrode 7006. Both the positive electrode terminal 7003 and the negative electrode terminal 7007 can be formed using a metal material such as aluminum. The positive electrode terminal 7003 and the negative electrode terminal 7007 are resistance-welded to a safety valve mechanism 7012 and the bottom of the battery can 7002, respectively. The safety valve mechanism 7012 is electrically connected to the positive electrode cap 7001 through a positive temperature coefficient (PTC) element 7011. The safety valve mechanism 7012 cuts off electrical connection between the positive electrode cap 7001 and the positive electrode 7004 when the internal pressure of the battery exceeds a predetermined threshold value. Further, the PTC element 7011, which serves as a thermally sensitive resistor whose resistance increases as temperature rises, limits the amount of current by increasing the resistance, in order to prevent abnormal heat generation. Note that barium titanate (BaTiO₃)-based semiconductor ceramic or the like can be used for the PTC element 7011.

Note that in this embodiment, the coin-type lithium-ion secondary battery and the cylindrical lithium-ion secondary battery are given as examples of the lithium-ion secondary battery; however, any of lithium secondary batteries with a variety of shapes, such as a sealed lithium-ion secondary battery and a square-type lithium-ion secondary battery, can be used. Further, a structure in which a plurality of positive electrodes, a plurality of negative electrodes, and a plurality of separators are stacked or wound may be employed.

This embodiment can be implemented in combination with any of the other embodiments as appropriate.

### Embodiment 4

The lithium-ion secondary battery of one embodiment of the present invention can be used for power supplies of a variety of electric devices which can be operated with electric power.

Specific examples of electric devices each utilizing the lithium-ion secondary battery of one embodiment of the present invention are as follows: display devices of televisions, monitors, and the like, lighting devices, desktop personal computers and laptop personal computers, word processors, image reproduction devices which reproduce still images or moving images stored in recording media such as digital versatile discs (DVDs), portable or stationary music reproduction devices such as compact disc (CD) players and digital audio players, portable or stationary radio receivers, recording reproduction devices such as tape recorders and IC recorders (voice recorders), headphone stereos, stereos, clocks such as table clocks and wall clocks, cordless phone handsets, transceivers, cell phones, car phones, portable or stationary game machines, calculators, portable information terminals, electronic notepads, e-book readers, electronic translators, audio input devices such as microphones, cameras such as still cameras and video cameras, electric shavers, high-frequency heating appliances such as microwave ovens, electric rice cookers, electric washing machines, electric vacuum cleaners, water heaters, electric fans, hair dryers, air-conditioning systems such as humidifiers, dehumidifiers, and air conditioners, dishwashers, dish dryers, clothes dryers, futon dryers, electric refrigerators, electric freezers, electric refrigerator-freezers, freezers for preserving DNA, flashlights, electric power tools, smoke detectors, and health equipment and medical equipment such as hearing aids, cardiac pacemakers, portable X-ray equipment, electric massagers, and dialyzers. Further, industrial equipment such as guide lights, traffic lights, meters such as gas meters and water meters, belt conveyors, elevators, escalators, industrial robots, wireless relay stations, base stations of cell phones, power storage systems, and power storage devices for leveling the amount of power supply and smart grid can be given. In addition, moving objects driven by electric motors using electric power from the lithium-ion secondary batteries are also included in the category of electric devices. Examples of the moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, agricultural machines, motorized bicycles including motor-assisted bicycles, motorcycles, electric wheelchairs, electric carts, boats, ships, submarines, aircrafts such as fixed-wing aircraft and rotary-wing aircraft, rockets, artificial satellites, space probes, rovers, and spacecrafts.

In the electric devices, the lithium-ion secondary battery of one embodiment of the present invention can be used as a main power supply for supplying enough electric power for almost the whole power consumption. Alternatively, in the electric devices, the lithium-ion secondary battery of one embodiment of the present invention can be used as an uninterruptible power supply which can supply electric power to the electric devices when the supply of electric power from the main power supply or a commercial power supply is stopped. Still alternatively, in the electric devices, the lithium-ion secondary battery of one embodiment of the present invention can be used as an auxiliary power supply for supplying electric power to the electric devices at the same time as the power supply from the main power supply or a commercial power supply.

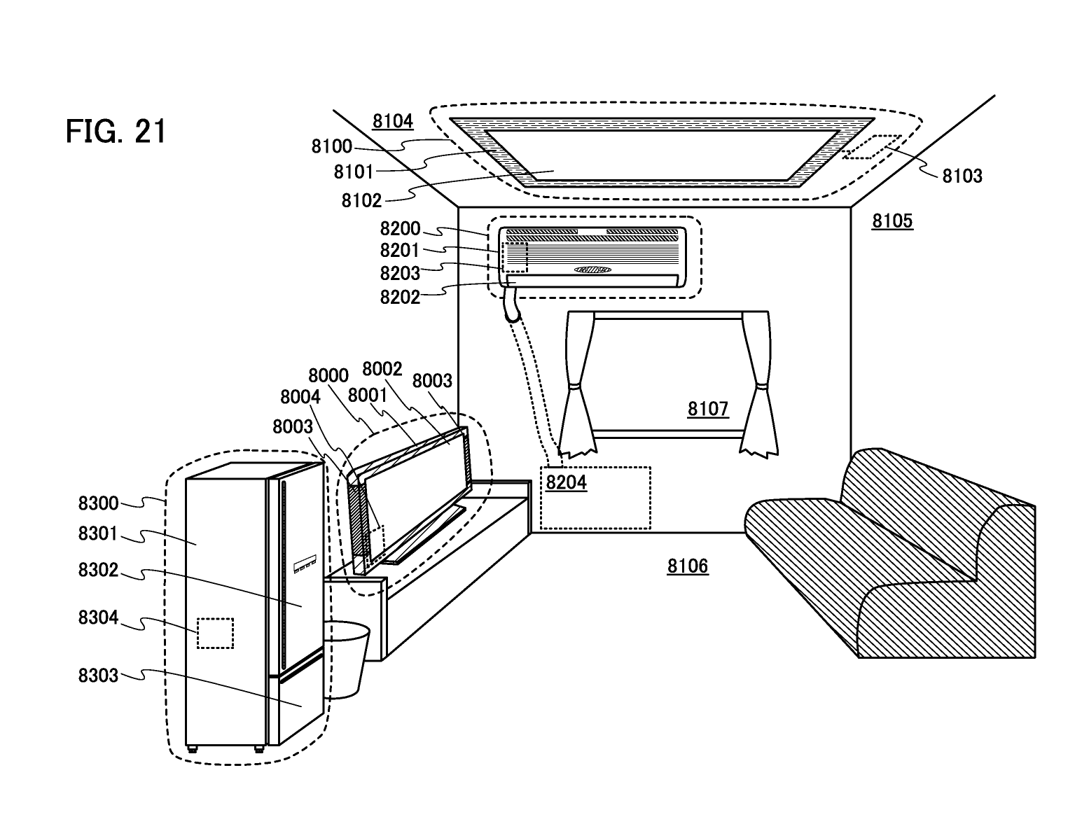

FIG. 21 illustrates specific structures of the electric devices. In FIG. 21, a display device 8000 is an example of an electric device including a lithium-ion secondary battery 8004 of one embodiment of the present invention. Specifically, the display device 8000 corresponds to a display device for TV broadcast reception and includes a housing 8001, a display portion 8002, speaker portions 8003, and the lithium-ion secondary battery 8004. The lithium-ion secondary battery 8004 is provided in the housing 8001. The display device 8000 can receive electric power from a commercial power supply. Alternatively, the display device 8000 can use electric power stored in the lithium-ion secondary battery 8004. Thus, the display device 8000 can be operated with the use of the lithium-ion secondary battery 8004 as an uninterruptible power supply even when electric power cannot be supplied from a commercial power supply because of power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides TV broadcast reception.

In FIG. 21, a stationary lighting device 8100 is an example of an electric device including a lithium-ion secondary battery 8103 of one embodiment of the present invention. Specifically, the lighting device 8100 includes a housing 8101, a light source 8102, and a lithium-ion secondary battery 8103. Although FIG. 21 illustrates the case where the lithium-ion secondary battery 8103 is provided in a ceiling 8104 on which the housing 8101 and the light source 8102 are installed, the lithium-ion secondary battery 8103 may be provided in the housing 8101. The lighting device 8100 can receive electric power from a commercial power supply. Alternatively, the lighting device 8100 can use electric power stored in the lithium-ion secondary battery 8103. Thus, the lighting device 8100 can be operated with the use of the lithium-ion secondary battery 8103 as an uninterruptible power supply even when electric power cannot be supplied from a commercial power supply because of power failure or the like.

Note that although the stationary lighting device 8100 provided in the ceiling 8104 is illustrated in FIG. 21 as an example, the lithium-ion secondary battery of one embodiment of the present invention can be used in a stationary lighting device provided in, for example, a wall 8105, a floor 8106, a window 8107, or the like other than the ceiling 8104. Alternatively, the lithium-ion secondary battery can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 21, an air conditioner including an indoor unit 8200 and an outdoor unit 8204 is an example of an electric device including a lithium-ion secondary battery 8203 of one embodiment of the invention. Specifically, the indoor unit 8200 includes a housing 8201, an air outlet 8202, and a lithium-ion secondary battery 8203. Although FIG. 21 illustrates the case where the lithium-ion secondary battery 8203 is provided in the indoor unit 8200, the lithium-ion secondary battery 8203 may be provided in the outdoor unit 8204. Alternatively, the lithium-ion secondary batteries 8203 may be provided in both the indoor unit 8200 and the outdoor unit 8204. The air conditioner can receive electric power from a commercial power supply. Alternatively, the air conditioner can use electric power stored in the lithium-ion secondary battery 8203. Particularly in the case where the lithium-ion secondary batteries 8203 are provided in both the indoor unit 8200 and the outdoor unit 8204, the air conditioner can be operated with the use of the lithium-ion secondary battery 8203 as an uninterruptible power supply even when electric power cannot be supplied from a commercial power supply because of power failure or the like.

Note that although the split-type air conditioner including the indoor unit and the outdoor unit is illustrated in FIG. 21 as an example, the lithium-ion secondary battery of one embodiment of the present invention can be used in an air conditioner in which the functions of an indoor unit and an outdoor unit are integrated in one housing.

In FIG. 21, an electric refrigerator-freezer 8300 is an example of an electric device including a lithium-ion secondary battery 8304 of one embodiment of the present invention. Specifically, the electric refrigerator-freezer 8300 includes a housing 8301, a door for a refrigerator 8302, a door for a freezer 8303, and the lithium-ion secondary battery 8304. The lithium-ion secondary battery 8304 is provided in the housing 8301 in FIG. 21. The electric refrigerator-freezer 8300 can receive electric power from a commercial power supply. Alternatively, the electric refrigerator-freezer 8300 can use electric power stored in the lithium-ion secondary battery 8304. Thus, the electric refrigerator-freezer 8300 can be operated with the use of the lithium-ion secondary battery 8304 as an uninterruptible power supply even when electric power cannot be supplied from a commercial power supply because of power failure or the like.

Note that among the electric devices described above, a high-frequency heating apparatus such as a microwave oven and an electric device such as an electric rice cooker require high power in a short time. The tripping of a breaker of a commercial power supply in use of an electric device can be prevented by using the lithium-ion secondary battery of one embodiment of the present invention as an auxiliary power supply for supplying electric power which cannot be supplied enough by a commercial power supply.

In addition, in a time period when electric devices are not used, particularly when the proportion of the amount of electric power which is actually used to the total amount of electric power which can be supplied from a commercial power supply source (such a proportion referred to as a usage rate of electric power) is low, electric power can be stored in the lithium-ion secondary battery, whereby the usage rate of electric power can be reduced in a time period when the electric devices are used. For example, in the case of the electric refrigerator-freezer 8300, electric power can be stored in the lithium-ion secondary battery 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the lithium-ion secondary battery 8304 is used as an auxiliary power supply; thus, the usage rate of electric power in daytime can be reduced.

This embodiment can be implemented in combination with any of the other embodiments as appropriate.

### Embodiment 5

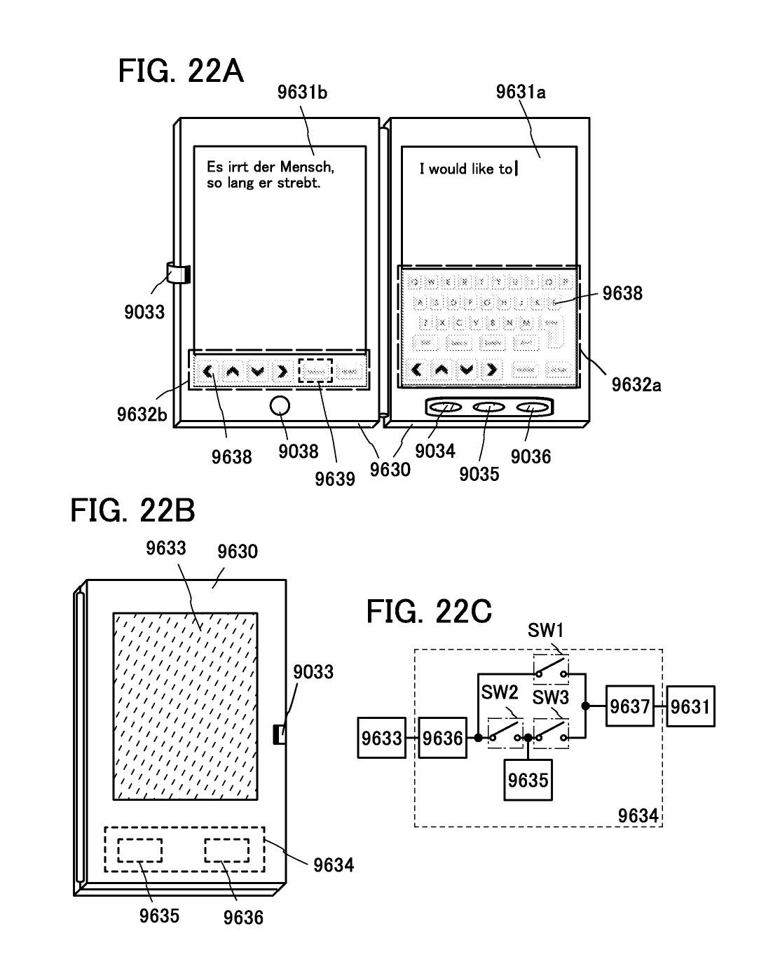

Next, a portable information terminal which is an example of electric devices will be described with reference to FIGS. 22A to 22C.

FIGS. 22A and 22B illustrate a tablet terminal which can be folded. FIG. 22A illustrates the tablet terminal in the state of being unfolded. The tablet terminal includes a housing 9630, a display portion 9631a, a display portion 9631b, a display-mode switching button 9034, a power button 9035, a power-saving-mode switching button 9036, a clasp 9033, and an operation button 9038.

A touch panel area 9632a can be provided in part of the display portion 9631a, in which area, data can be input by touching displayed operation keys 9638. Note that half of the display portion 9631a has only a display function and the other half has a touch panel function. However, the structure of the display portion 9631a is not limited to this, and all the area of the display portion 9631a may have a touch panel function. For example, a keyboard can be displayed on the whole display portion 9631a to be used as a touch panel, and the display portion 9631b can be used as a display screen.

A touch panel area 9632b can be provided in part of the display portion 9631b like in the display portion 9631a. When a keyboard display switching button 9639 displayed on the touch panel is touched with a finger, a stylus, or the like, a keyboard can be displayed on the display portion 9631b.

The touch panel area 9632a and the touch panel area 9632b can be controlled by touch input at the same time.

The display-mode switching button 9034 allows switching between a landscape mode and a portrait mode, color display and black-and-white display, and the like. The power-saving-mode switching button 9036 allows optimizing the display luminance in accordance with the amount of external light in use which is detected by an optical sensor incorporated in the tablet terminal. In addition to the optical sensor, other detecting devices such as sensors for determining inclination, such as a gyroscope or an acceleration sensor, may be incorporated in the tablet terminal.

Although the display area of the display portion 9631a is the same as that of the display portion 9631b in FIG. 22A, one embodiment of the present invention is not particularly limited thereto. The display area of the display portion 9631a may be different from that of the display portion 9631b, and further, the display quality of the display portion 9631a may be different from that of the display portion 9631b. For example, one of the display portions 9631a and 9631b may display higher definition images than the other.

FIG. 22B illustrates the tablet terminal in the state of being closed. The tablet terminal includes the housing 9630, a solar cell 9633, a charge and discharge control circuit 9634, a battery 9635, and a DC-DC converter 9636. FIG. 22B illustrates an example where the charge and discharge control circuit 9634 includes the battery 9635 and the DC-DC converter 9636. The lithium-ion secondary battery described in the above embodiment is used as the battery 9635.

Since the tablet terminal can be folded, the housing 9630 can be closed when the tablet terminal is not in use. Thus, the display portions 9631a and 9631b can be protected, which permits the tablet terminal to have high durability and improved reliability for long-term use.

The tablet terminal illustrated in FIGS. 22A and 22B can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 9633, which is attached on a surface of the tablet terminal, can supply electric power to a touch panel, a display portion, an image signal processor, and the like. Note that the solar cell 9633 can be provided on one or both surfaces of the housing 9630 and thus the battery 9635 can be charged efficiently.

The structure and operation of the charge and discharge control circuit 9634 illustrated in FIG. 22B will be described with reference to a block diagram of FIG. 22C. FIG. 22C illustrates the solar cell 9633, the battery 9635, the DC-DC converter 9636, a converter 9637, switches SW1 to SW3, and a display portion 9631. The battery 9635, the DC-DC converter 9636, the converter 9637, and the switches SW1 to SW3 correspond to the charge and discharge control circuit 9634 in FIG. 22B.

First, an example of operation in the case where electric power is generated by the solar cell 9633 using external light will be described. The voltage of electric power generated by the solar cell is raised or lowered by the DC-DC converter 9636 so that the electric power has a voltage for charging the battery 9635. When the display portion 9631 is operated with the electric power from the solar cell 9633, the switch SW1 is turned on and the voltage of the electric power is raised or lowered by the converter 9637 to a voltage needed for operating the display portion 9631. In addition, when display on the display portion 9631 is not performed, the switch SW1 is turned off and the switch SW2 is turned on so that the battery 9635 may be charged.

Although the solar cell 9633 is described as an example of a power generation means, there is no particular limitation on the power generation means, and the battery 9635 may be charged with any of the other means such as a piezoelectric element or a thermoelectric conversion element (Peltier element). For example, the battery 9635 may be charged with a non-contact power transmission module capable of performing charging by transmitting and receiving electric power wirelessly (without contact), or any of the other charge means used in combination.

It is needless to say that one embodiment of the present invention is not limited to the electric device illustrated in FIGS. 22A to 22C as long as the lithium-ion secondary battery described in the above embodiment is included.

### Embodiment 6

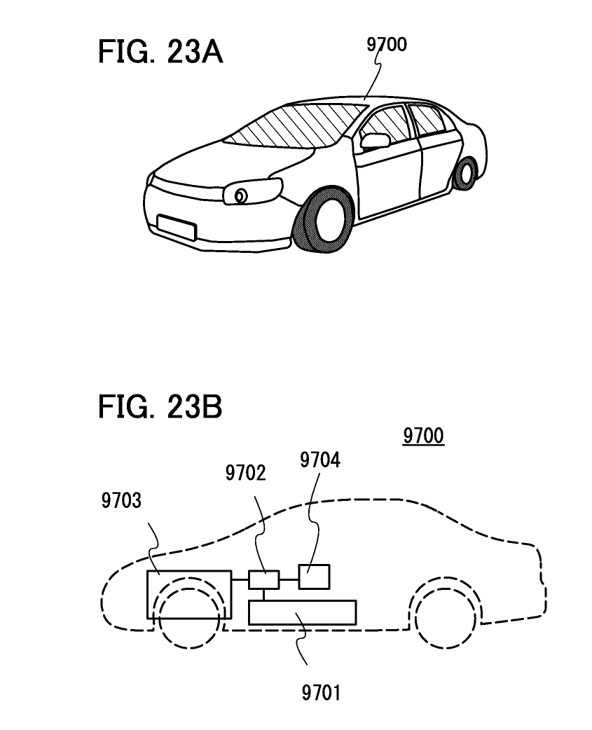

Further, an example of the moving object which is an example of the electric devices will be described with reference to FIGS. 23A and 23B.

Any of the lithium-ion secondary batteries described in Embodiments 1 to 3, can be used as a control battery. The control battery can be externally charged by electric power supply using a plug-in technique or contactless power feeding. Note that in the case where the moving object is an electric railway vehicle, the electric railway vehicle can be charged by electric power supply from an overhead cable or a conductor rail.

FIGS. 23A and 23B illustrate an example of an electric vehicle. An electric vehicle 9700 is equipped with a lithium-ion secondary battery 9701. The output of the electric power of the lithium-ion secondary battery 9701 is adjusted by a control circuit 9702 and the electric power is supplied to a driving device 9703. The control circuit 9702 is controlled by a processing unit 9704 including a ROM, a RAM, a CPU, or the like which is not illustrated.

The driving device 9703 includes a DC motor or an AC motor either alone or in combination with an internal-combustion engine. The processing unit 9704 outputs a control signal to the control circuit 9702 based on input data such as data on operation (e.g., acceleration, deceleration, or stop) of a driver or data during driving (e.g., data on an upgrade or a downgrade, or data on a load on a driving wheel) of the electric vehicle 9700. The control circuit 9702 adjusts the electric energy supplied from the lithium-ion secondary battery 9701 in accordance with the control signal of the processing unit 9704 to control the output of the driving device 9703. In the case where the AC motor is mounted, although not illustrated, an inverter which converts direct current into alternate current is also incorporated.

The lithium-ion secondary battery 9701 can be charged by external electric power supply using a plug-in technique. For example, the lithium-ion secondary battery 9701 is charged through a power plug from a commercial power supply. In this case, the lithium-ion secondary battery 9701 can be charged by converting the supplied power into DC constant voltage having a predetermined voltage level through a converter such as an AC-DC converter. The use of the lithium-ion secondary battery of one embodiment of the present invention as the lithium-ion secondary battery 9701 can be conducive to, for example, a reduction in charging time, leading to an improvement in convenience. Moreover, the higher charging and discharging rate of the lithium-ion secondary battery 9701 can contribute to greater acceleration and excellent performance of the electric vehicle 9700. When the lithium-ion secondary battery 9701 itself can be more compact and more lightweight as a result of improved characteristics of the lithium-ion secondary battery 9701, the vehicle can be lightweight, leading to an increase in fuel efficiency.

This embodiment can be implemented in combination with any of the other embodiments as appropriate.

This application is based on Japanese Patent Application serial no. 2012-223677 filed with the Japan Patent Office on Oct. 5, 2012, the entire contents of which are hereby incorporated by reference.

What is claimed is:

1. An active material for a lithium-ion secondary battery, comprising:
a plurality of first layers and a plurality of second layers,
wherein the plurality of first layers comprise silicon,
wherein the plurality of second layers comprise silicon,
wherein a concentration of oxygen in the plurality of first layers is higher than a concentration of oxygen in the plurality of second layers, and
wherein the first layers and the second layers are alternately stacked.

2. The active material for a lithium-ion secondary battery according to claim 1, wherein the plurality of first layers comprise silicon oxide.

3. The active material for a lithium-ion secondary battery according to claim 1, wherein the plurality of second layers comprise a silicon alloy.

4. A negative electrode for a lithium-ion secondary battery comprising:
a current collector; and
an active material in contact with the current collector,
wherein the current collector includes a plurality of protrusion portions and a base portion connected to the plurality of protrusion portions,
wherein the plurality of protrusion portions extends in a direction substantially perpendicular to a surface of the current collector,
wherein the plurality of protrusion portions and the base portion are formed with the same material,
wherein the active material comprises:
a plurality of first layers and a plurality of second layers,
wherein the plurality of first layers comprise silicon,
wherein the plurality of second layers comprise silicon,
wherein a concentration of oxygen in the plurality of first layers is higher than a concentration of oxygen in the plurality of second layers, and
wherein the first layers and the second layers are alternately stacked.

5. The negative electrode for a lithium-ion secondary battery, according to claim 4, wherein the current collector comprises titanium.

6. The negative electrode for a lithium-ion secondary battery, according to claim 4, wherein an aspect ratio of the plurality of protrusion portions is greater than or equal to 0.2 and less than or equal to 2000.

7. The negative electrode for a lithium-ion secondary battery, according to claim 4, wherein a shape of the plurality of protrusion portions is a columnar shape, a conical shape, a pyramidal shape, or a plate shape.

8. The negative electrode for a lithium-ion secondary battery, according to claim 4, wherein at least one of the base portion and top surfaces of the protrusion portions have a region which is not in contact with the active material.

9. A lithium-ion secondary battery comprising:
a positive electrode;
the negative electrode according to claim 4; and
an electrolyte containing a lithium ion.

10. An electric appliance comprising the lithium-ion secondary battery according to claim 9.

11. A negative electrode for a lithium-ion secondary battery comprising:
a current collector; and
a negative electrode active material layer over the current collector,
wherein the negative electrode active material layer comprises:
an active material; and
a resin material having elasticity,
wherein the active material comprises a plurality of first layers and a plurality of second layers,
wherein the plurality of first layers comprise silicon,
wherein the plurality of second layers comprise silicon,
wherein a concentration of oxygen in the plurality of first layers is higher than a concentration of oxygen in the plurality of second layers, and
wherein the first layers and the second layers are alternately stacked.

12. The negative electrode for a lithium-ion secondary battery, according to claim 11, further comprising a conductive additive.

13. A lithium-ion secondary battery comprising:
a positive electrode;
the negative electrode according to claim 11; and
an electrolyte containing a lithium ion.

14. An electric appliance comprising the lithium-ion secondary battery according to claim 13.

15. A manufacturing method of a negative electrode for a lithium-ion secondary battery, the method comprising the step of:
forming an active material by using a deposition gas containing silicon,
wherein a plurality of times of momentary introduction of an oxidizing gas are performed during the step of forming the active material.

16. The manufacturing method of a negative electrode for a lithium-ion secondary battery according to claim 15, wherein the step of forming the active material is performed by momentarily using the deposition gas and the oxidizing gas.

17. The manufacturing method of a negative electrode for a lithium-ion secondary battery, according to claim 15, wherein the oxidizing gas comprises oxygen, ozone, dinitrogen monoxide, nitrogen dioxide, or dry air.

18. The manufacturing method of a negative electrode for a lithium-ion secondary battery, according to claim 15, further comprising the steps of:
forming a photoresist pattern over a current collector material, and
etching the current collector material with the use of the photoresist pattern as a mask to form a current collector including a plurality of protrusion portions and a base portion connected to the plurality of protrusion portions.

19. The manufacturing method of a negative electrode for a lithium-ion secondary battery, according to claim 18, wherein the step of forming the active material is performed so that the active material covers top surfaces and side surfaces of the protrusion portions and the top surface of the base portion.

20. The manufacturing method of a negative electrode for a lithium-ion secondary battery, according to claim 19, further comprising the step of:
partly removing the active material by anisotropic etching so that at least one of the base portion and top surfaces of the protrusion portions is exposed.
